(19) United States
(12) Patent Application Publication
(10) Pub. No.: US 2026/0078866 A1
(43) Pub. Date: Mar. 19, 2026

(54) SUPPORT DEVICES FOR HOLDING ITEMS AND METHODS OF MAKING AND USING THE SAME

(71) Applicant: Phifer Incorporated, Tuscaloosa, AL (US)

(72) Inventors: Beverly PHIFER, Tuscaloosa, AL (US); Timothy WILSON, Moundville, AL (US); Frank WINGARD, Tuscaloosa, AL (US)

(21) Appl. No.: 19/330,766

(22) Filed: Sep. 16, 2025

Related U.S. Application Data
(60) Provisional application No. 63/695,173, filed on Sep. 16, 2024.

(51) Int. Cl. F16M 13/00

(52) U.S. Cl. CPC F16M 13/00; F16M 2200/08

(57) ABSTRACT

The disclosure is directed to support devices and methods of making and using the same. A support device of the disclosure may be provided to hold one or more items, such as an electronic device. The support device can include a support device for holding an item, the support device comprising: (A) a base; (B) a stand assembly pivotally attached to the base by a hinge, and the stand assembly including a first rotation assembly; (C) a platform assembly that includes a second rotation assembly, engaged with the first rotation assembly, such that the platform assembly, with second rotation assembly, is rotatably attached to and supported on the stand body of the stand assembly; and the platform assembly is rotatably and removably supported on the stand body, and the platform assembly including an attachment mechanism that is configured to attach to a user device.

### RELATED PATENT APPLICATION AND PRIORITY

This application claims priority to U.S. Provisional Patent Application 63/695,173 filed Sep. 16, 2024, the content of which is incorporated herein by reference in its entirety.

### BACKGROUND OF THE DISCLOSURE

The disclosure is directed to and relates to support devices to support a personal electronic device and/or to support other items and methods of making and using the same. Various devices have been used in the past to support personal electronic devices, such as an electronic tablet computer, a cell phone,, personal digital assistant (PDA), note pad, and various other items, for example. However, known devices for supporting such items have shortcomings with regard to some objectives and benefits.

### BRIEF SUMMARY OF THE DISCLOSURE

The disclosure is directed to and relates to support devices and methods of making and using the same. A support device of the disclosure may be provided to hold one or more items, such as an electronic device. The support device can include a support device for holding an item, the support device comprising: (A) a base; (B) a stand assembly, including a stand body, pivotally attached to the base by a hinge, and the stand assembly including a first rotation assembly; (C) a platform assembly that includes a second rotation assembly, and the second rotation assembly engaged with the first rotation assembly such that the platform assembly, with second rotation assembly, is rotatably attached to and supported on the stand body of the stand assembly; and the platform assembly is rotatably and removably supported on the stand body, and the platform assembly including an attachment mechanism that is configured to attach to a user device, the attachment mechanism including: (a) a first gripper assembly including a first gripper; and (b) a second gripper assembly including a second gripper, the first gripper assembly and the second gripper assembly being of the same construct so as to be interchangeable.

### BRIEF DESCRIPTION OF THE DRAWINGS

The present disclosure can be more fully understood by reading the following detailed description together with the accompanying drawings, in which like reference indicators are used to designate like or similar elements, and in which:

FIG. 1 is a front perspective view showing a support device, in accordance with principles of the disclosed subject matter.

FIG. 2 is a further front perspective view of the support device of FIG. 1, or device similar thereto, with drawer of a base assembly pulled out, in accordance with principles of the disclosed subject matter.

FIG. 3 is a top perspective view of the base assembly of FIG. 1, or device similar thereto, with drawer pulled out, in accordance with principles of the disclosure.

FIG. 4 is a bottom perspective view of the base assembly of FIG. 1, or device similar thereto, in accordance with principles of the disclosure.

FIG. 5 is a front perspective view of the stand assembly of FIG. 1, or device similar thereto, in accordance with principles of the disclosure.

FIG. 6 is a back perspective view of the of the stand assembly of FIG. 1, or device similar thereto, in accordance with principles of the disclosure.

FIG. 7 is a top view of a hinge pin assembly, in accordance with principles of the disclosed subject matter.

FIG. 8 is a front perspective view of the stand assembly of FIG. 1, or device similar thereto, with the drawer shown in exploded view, in accordance with principles of the disclosed subject matter.

FIG. 9 is a partial cross-sectional side view of a ball plunger assembly, in accordance with principles of the disclosure.

FIG. 10 is a top perspective of the platform assembly of FIG. 1, or device similar thereto, in accordance with principles of the disclosure.

FIG. 11 is a top view of a platform assembly of FIG. 1, or device similar thereto, in accordance with principles of the disclosure.

FIG. 12 is a front perspective view of the platform assembly of FIG. 1, or device similar thereto, without the gripper assemblies, in accordance with principles of the disclosure.

FIG. 12B is a back perspective view of the platform assembly of FIG. 1, or device similar thereto, without the gripper assemblies, in accordance with principles of the disclosure.

FIG. 13 is an exploded, back perspective view of the platform assembly of FIG. 1, or device similar thereto, showing gearbox covers spaced from a body portion, in accordance with principles of the disclosure.

FIG. 14 is a back view of the platform assembly of FIG. 1, or device similar thereto, showing gearbox covers removed from the body portion, in accordance with principles of the disclosure.

FIG. 14B is a perspective view of an inner surface of the gearbox cover shown in FIG. 13, or cover similar thereto, in accordance with principles of the disclosure.

FIG. 14C is a perspective view of an outer surface of the gearbox cover shown in FIG. 13, or cover similar thereto, in accordance with principles of the disclosure.

FIG. 15 is a top perspective view of the left gripper assembly of FIG. 1, or device similar thereto, in accordance with principles of the disclosure.

FIG. 16 is a bottom perspective view of the left gripper assembly of FIG. 1, or device similar thereto, in accordance with principles of the disclosure.

FIG. 17 is a top perspective view of the right gripper assembly of FIG. 1, or device similar thereto, in accordance with principles of the disclosure.

FIG. 17B is a bottom perspective view of the right gripper assembly of FIG. 1, or device similar thereto, in accordance with principles of the disclosure.

FIG. 18 is a top perspective of the base assembly with drawer pulled out, with an “index card” positioned in the drawer, in accordance with principles of the disclosure.

FIG. 19 is a bottom perspective view of the sliding drawer, of the base assembly, or device similar thereto, in accordance with principles of the disclosure.

FIG. 19B is a further bottom perspective view of the sliding drawer of the base assembly, or device similar thereto, in accordance with principles of the disclosure.

FIG. 20 is a top perspective view of the drawer of the base assembly, or device similar thereto, in accordance with principles of the disclosure.

FIG. 21 is a top perspective view of the sliding drawer of the stand assembly, or device similar thereto, in accordance with principles of the disclosure.

FIG. 22 is a bottom perspective view of the sliding drawer of the stand assembly, or device similar thereto, in accordance with principles of the disclosure.

FIG. 23 is a perspective view of a travel pin, in accordance with principles of the disclosure.

FIG. 24 is a schematic diagram of a coiled spring that can provide the stylus holder shown in FIG. 1, or holder similar thereto, in accordance with principles of the disclosure.

FIG. 25 is a front partial perspective view of a support device, in accordance with principles of the disclosure.

FIG. 26 is a side perspective view of the support device of FIG. 25, or device similar thereto, in accordance with principles of the disclosure.

FIG. 26B is a cutaway view of portion A of the support device of FIG. 26, in accordance with principles of the disclosure.

FIG. 27 is a top, perspective view of a hinge pin assembly, in accordance with principles of the disclosed subject matter.

FIG. 28 is a back, partial view of a lower back corner of a stand assembly, in accordance with principles of the disclosure.

### DETAILED DESCRIPTION OF THE DISCLOSURE

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

As used herein, any term in the singular may be interpreted to be in the plural, and alternatively, any term in the plural may be interpreted to be in the singular.

The disclosure provides support devices and methods of making and using the same. The support devices described may be used to hold a wide variety of personal electronic devices such as an electronic tablet computer, cell phone, personal digital assistant (PDA), land phone, smart phone, car phone, computer terminal, texting device, satellite radio device, voice over IP device, and/or any other mobile user device as well as other items, such as books, recipes or other documents, for example.

The support devices of this disclosure can hold one or more items. In particular, the support device(s) is provided to hold an electronic tablet, i.e. a tablet, and allow for various manipulation of the tablet as supported upon the support device. In particular, the support device provides for angular positioning of a cell phone held thereupon, as well as provides for rotational manipulation of a cell phone held on the support device. Such rotational manipulation provides for portrait viewing of a tablet or landscape viewing of a tablet, as may be desired. The support device of the disclosure provides a variety of manipulation capabilities, which (among other features) distinguish the support device of the disclosure over known devices.

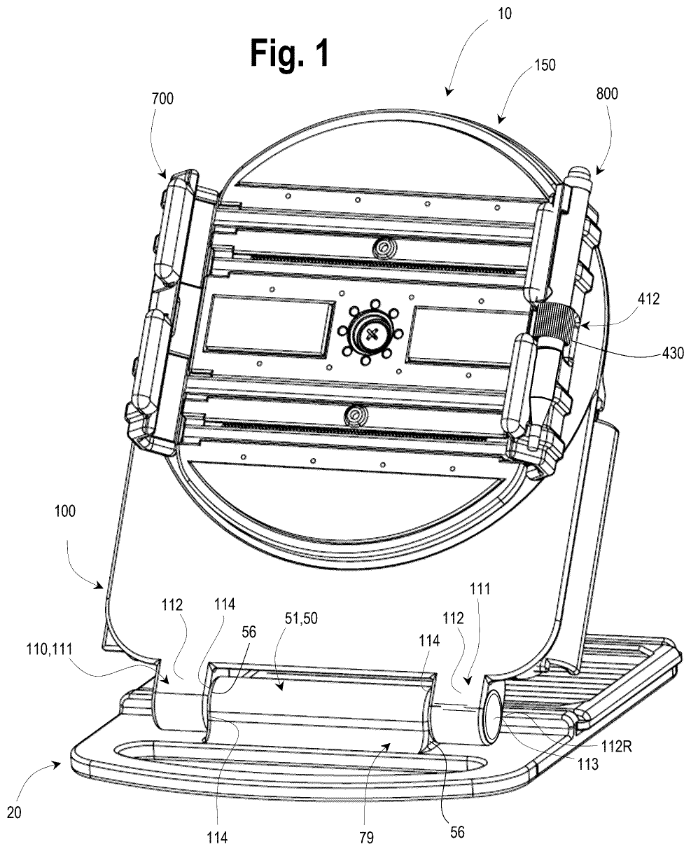

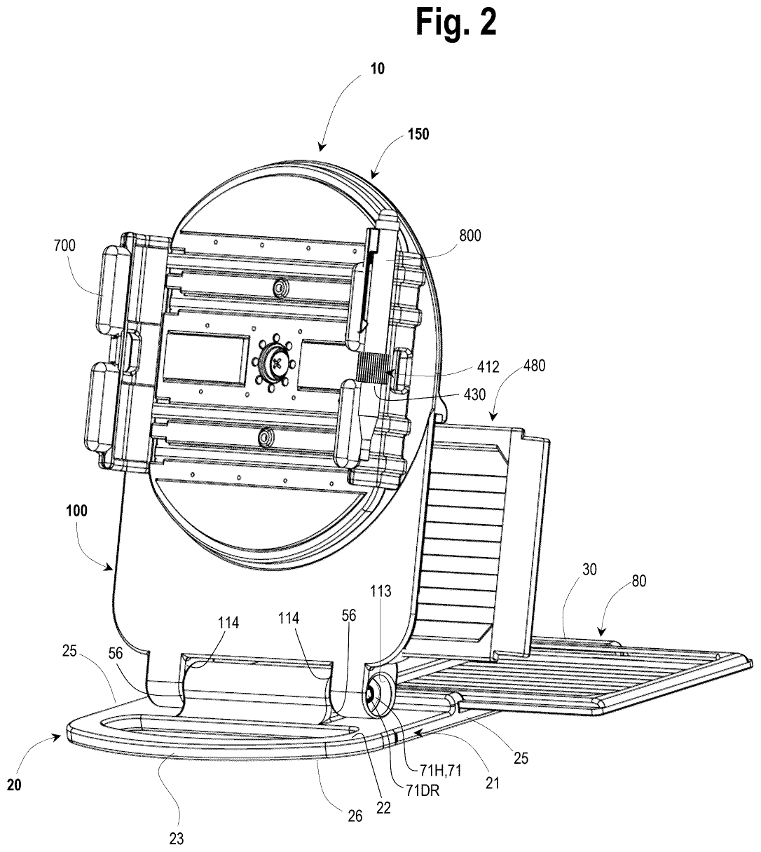

FIG. 1 is a front perspective view showing a support device 10 provided to support a user device, in accordance with principles of the disclosed subject matter. FIG. 2 is a further front perspective view of the support device of FIG. 1, or device similar thereto, with drawers (as described below) of the support device 10 open, in accordance with principles of the disclosed subject matter. The support device 10 can include a base assembly or base 20 and a stand assembly or stand 100. The stand assembly or stand 100 can be hingedly or pivotally attached to the base assembly 20 as described below. The support device 10 can further include a platform assembly or platform 150. The stand assembly 100 can be rotatably mounted upon the base assembly 20. In particular, the stand assembly 100 can be rotatably mounted, on the base assembly, so as to adjust an angle of the stand assembly 100 as described in detail below. The platform assembly 150 can be mounted on the stand assembly and can support a tablet or other user device. The platform assembly 150 can include gripper assemblies 699. The gripper assemblies 699 can be described as an attachment mechanism. The gripper assemblies 699 can include a left gripper assembly 700 (which can also be described as a first gripper assembly 700) and a right gripper assembly 800 (which can also be described as a second gripper assembly 800). The gripper assemblies 700, 800, with grippers 710, 810, respectively, can serve to support a tablet, other user device, or any other object as desired. The gripper assemblies and grippers described herein can be described as supports, or attachment mechanisms, that serve to support and/or attach to a user device, such as a tablet.

The gripper assemblies 700, 800 can include left support rods 730 and right support rods 830, respectively. The grippers 710, 810, of the gripper assemblies 700, 800 respectively, can be mounted on the ends of the support rods 730, 830, respectively. The support rods 730, 830, gripper assemblies 700, 800 and various related mechanisms can provide for a cell phone to be securely retained on the platform assembly 150.

With further reference to FIGS. 1 and 2, further details of the base assembly 20 will be described. As described above, the base assembly 20 can include a body or base body portion 21. The base body portion 21 can include a top face 22 and a bottom face 26. The base body portion 21 can also include a front edge 23, a back edge 24, and side edges 25.

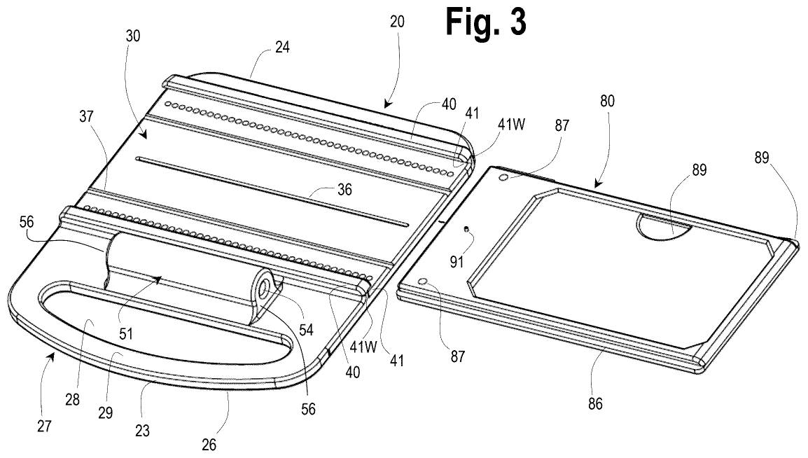

The base portion can include a handle 27, as shown in FIG. 3. The handle 27 can include an opening 28 and grab portion 29. The handle 27 can be used to grab and transport the support device 10.

The base assembly 20 can also include a receiving cavity 30. The receiving cavity 30 can receive a sliding drawer or drawer 80. The sliding drawer 80 can serve to provide a storage compartment in which a notepad or notes, for example, can be stored. Further details are described below.

With further reference to FIG. 1, the stand assembly 100 can include opposing hinge barrels 111 of a hinge barrel assembly 110. The hinge barrels 111 can hingedly or pivotally support the stand assembly 100 upon the base assembly 20. The hinge barrels 111 can be part of a hinge assembly 79 of the support device 10. The base assembly 20 can include a hinge barrel 51 of a hinge barrel assembly 50 (of the base assembly 20, i.e. of the base 20). The hinge assembly 79, as described herein, can include the hinge barrel assembly 50, the hinge barrel assembly 110, and a hinge pin assembly 70. The hinge pin assembly 70 can serve to connect the assemblies 50, 110, so as to connect the base 20 and the stand assembly 100.

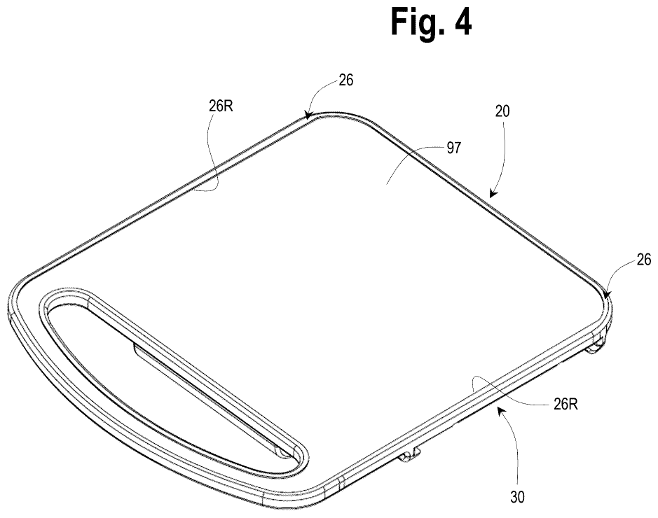

FIG. 3 is a top perspective view of the base assembly 20 with drawer 80 pulled out. FIG. 4 is a bottom perspective view of the base 20. As shown in FIGS. 3 and 4, the base assembly 20 can include the bottom face 26. The bottom face 26 and/or components attached to the bottom face can be flat so as to stably support the support device 10 on a surface, such as a surface of a desk, for example. The bottom face 26 can include a recess or recessed portion 26R, which can be provided with or fitted with a pad, foam pad and/or nonslip material 97. The base assembly could also constructed of metal, be a magnet and/or can provide attachment capability of the support device 10 to a magnet. A portion of the base assembly can itself be magnetized so as to provide attachment to other metal. The pad 97 can provide a cushioned and/or slip resistant surface. The bottom face 26 can be provided with openings, cavities, or slots so as to retain devices and/or so as to provide mounting capability to other structure or surfaces. In general, the base assembly 20 can be configured to be mounted on a particular surface as desired.

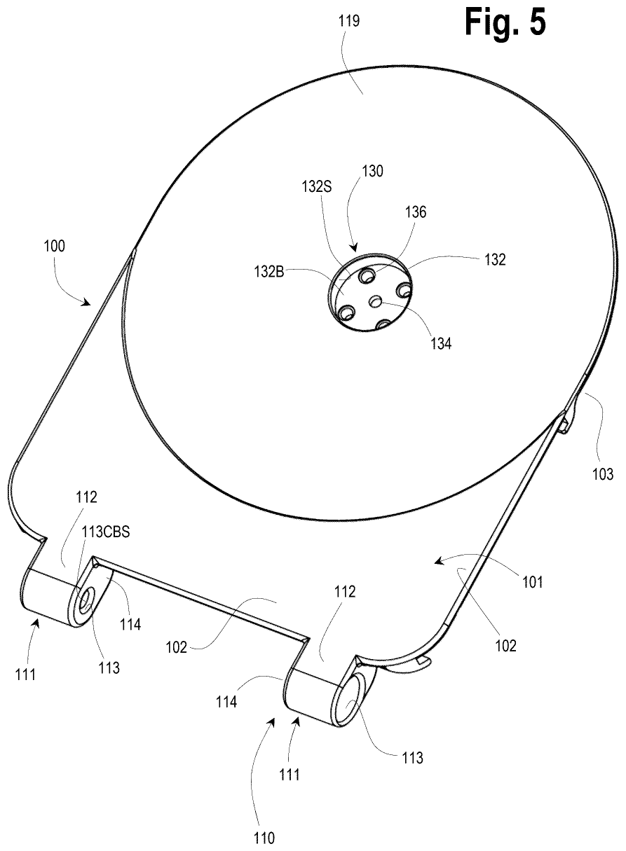

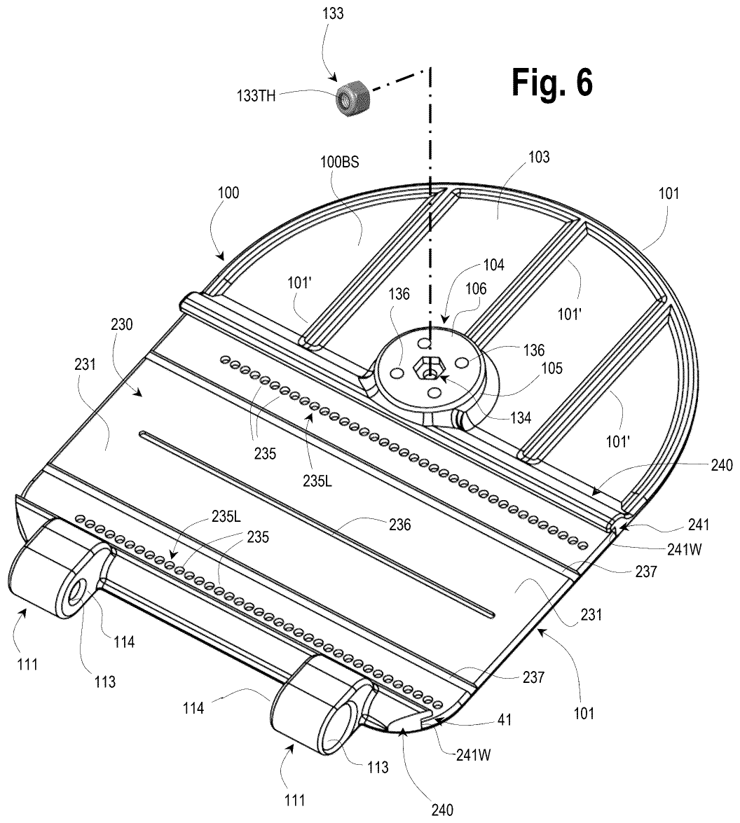

FIG. 5 is a front perspective view of the stand assembly 100. FIG. 6 is a back perspective view of the stand assembly 100.

The stand assembly 100, as shown in FIGS. 1, 2, 5 and 6 can include a stand body portion 101, i.e. a stand body 101. The stand body portion 101 can include or constitute a central or core portion of the stand assembly 100. The stand body portion 101 can include a top face 102 and a bottom or back face 103. The stand body portion can include reinforcement ribs 101′that can add structural strength to the stand body portion 101.

As described above, the stand assembly 100 can include hinge structure so as to hingedly, pivotally, or pivotably attach to the base assembly 20. The base assembly 20 can include the hinge barrel assembly 50, as described above and as shown in FIGS. 1 and 2, in particular. The hinge barrel assembly 50 can include the hinge barrel 51.

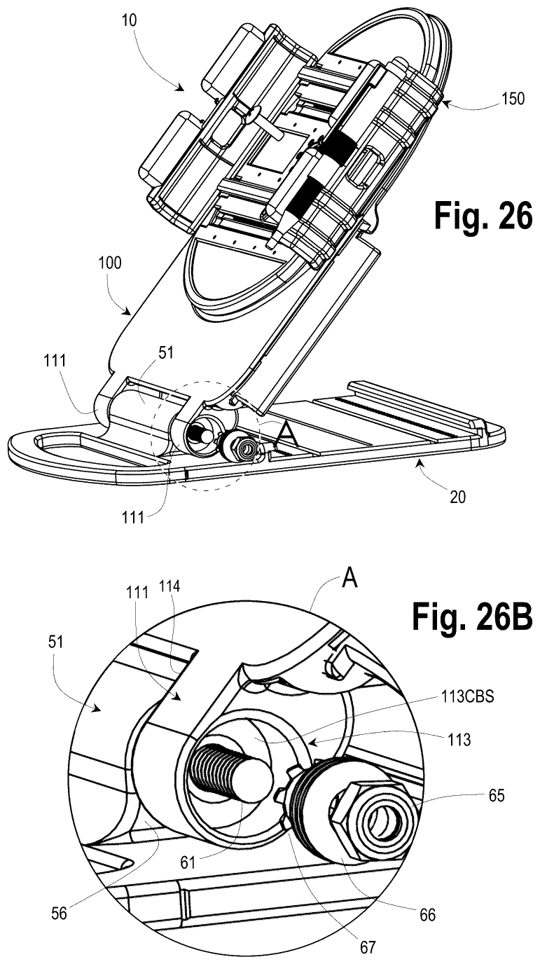

The stand assembly 100 can include the hinge barrel assembly 110. The hinge barrel assembly 110 can include opposing hinge barrels 111. Each of the hinge barrels 111 can include hinge pin holes or bores 113. Each of the bores 113 can be provided with a counterbore 113CBS (see FIG. 5 and FIG. 26B). Each of the bores 113can house a pin, threaded pin, screw or bolt 71, of the hinge pin assembly 70.

Each of the opposing hinge barrels 111 can be of similar structure, but in mirror image of each other. A hinge barrel 111 can include a front face 112 and a rear face 112R. Each hinge barrel 111 can include an inner contact face 114. The inner contact face 114 can be in frictional contact with a corresponding outer face or contact face 56 of hinge barrel 51. An amount of frictional force, resistant to rotation of the stand assembly 100 relative to the base assembly 20, can be adjusted as described below.

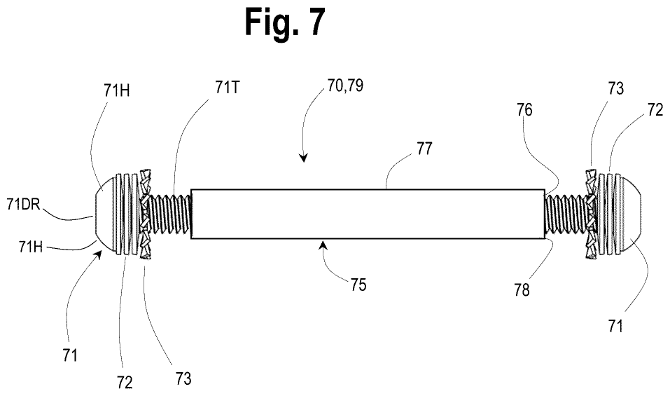

To explain further, a hinge assembly 79 can include the hinge barrel assembly 110 and the hinge barrel assembly 50. The hinge assembly 79 can also include various other components that can be provided so as to attach the hinge barrel assembly 50 and the hinge barrel assembly 110 (which includes opposing hinge barrels 111). The opposing hinge barrels 111 can encompass or enclose a standoff 75. Such a standoff 75 is shown in FIG. 7. The standoff 75 can be a female threaded standoff 75, which accepts bolts, pins or screws to be threaded into opposing ends of the standoff 75. The hinge barrel 111 (of the stand assembly 100) can include a hinge pin hole or bore 113. The hinge pin bore 113 can pass through a horizontal extent or depth of a respective hinge barrel 111.

Relatedly, FIG. 7 is a top view of a hinge pin assembly 70, in accordance with principles of the disclosed subject matter. As shown in FIG. 7, the standoff 75 can be in the form of a female, internally threaded standoff that includes opposing threaded bores 76 that extend in from each end surface 78 of the standoff 75. The threaded bores 76 can respectively receive opposing pins or screws 71 as shown in FIGS. 1 and 7. The standoff 75 can be provided with an outer surface 77. The outer surface 77 of the standoff 75 can interface with and be enclosed by an inner surface of the hinge pin bore 54 (see FIG. 2 and FIG. 3) through which the standoff 75 extends. The standoff 75 can be frictionally retained within the hinge pin bore 54.

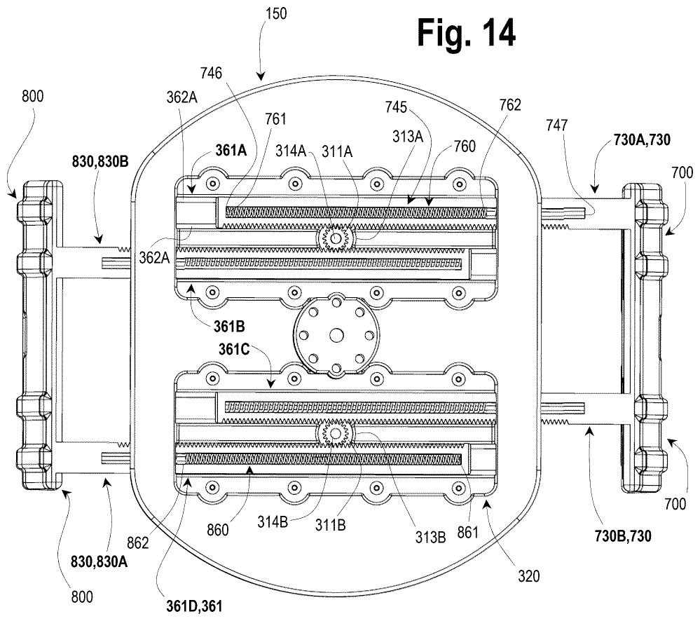

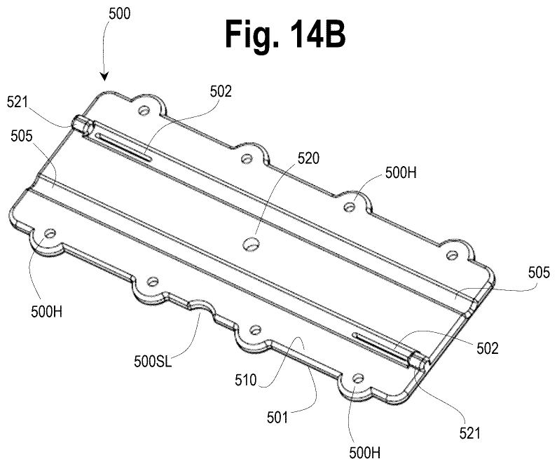

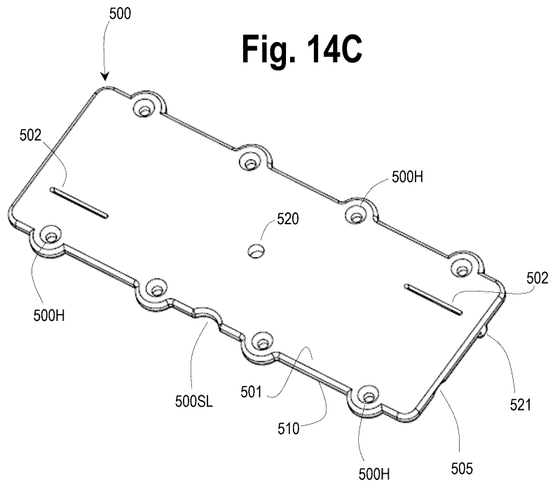

The pins 71 of the hinge assembly 79 can be threaded pins or screws 71 with threads 71T. The pins or screws 71 can include head 71H and drive 71DR, such as a Philips or star drive, for example. On both sides, a threaded pin 71 can pass through the hinge barrel 111 and into hinge barrel 51, i.e. into bore 54 (see FIGS. 1 and 3) of housing standoff 75. Accordingly, each hinge barrel 111 can be “sandwiched” between a head 71H of the pin 71 and a contact surface 56 of the hinge barrel 51, i.e. with the head 71H of the pin 71 seated on a counterbore surface 113CBS (see FIG. 1 and FIG. 26B). The standoff 75 can be threaded so that the bore 54 does not have to be threaded. For example, the standoff 75 can be metal and the hinge barrel 51 be plastic. The washers 72, 73 (see FIG. 14) can assist in maintaining the threaded pin 71 in a fastened or tightened disposition. Accordingly, the pins 71 can be tightened against opposing hinge barrels 111, i.e. so as to tighten the hinge barrels 111 between the hinge barrel 51 the screw head 71H. A resulting frictional relationship can both provide rotation, by a user, and prevent undue rotation, i.e. until some predetermined force is applied by the user. Accordingly, the friction fit can allow a user to position the stand assembly or stand 100 relative to the base assembly 20 at a desired angle, until the user applies a required pressure to manipulate the support device 10 so as to change the arrangement.

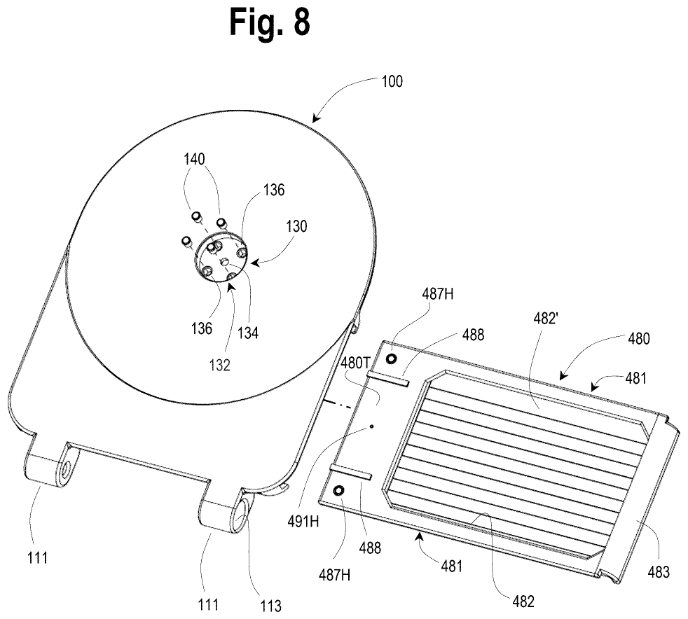

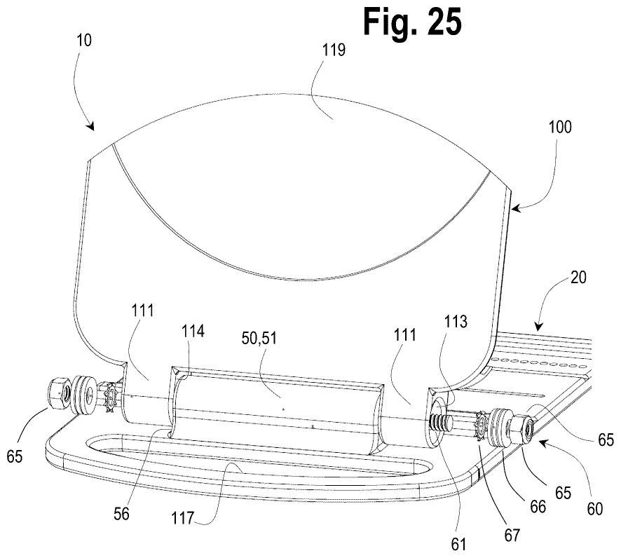

As shown in FIG. 7, the hinge pin assembly 70 can include the standoff 75, the pins 71, and washers 72, 73. The washer 72 can include a spring lock washer (4 MM e.g.), a steel Belleville disc spring washer, or other washer. The washer 73 can include a lock washer, external tooth lock washer, or other washer. The pin 71 can be a threaded-locking button-head socket screw, for example (such as 8-32 button head screw, e.g.). Other screws and/or washers can be utilized as desired. For example, FIGS. 25 and 26 provide an alternative arrangement as described below. As described above, FIG. 5 is a front perspective view of the stand assembly 100 of FIG. 1, or device similar thereto, in accordance with principles of the disclosed subject matter. FIG. 6 is a back perspective view of the stand assembly 100, or device similar thereto, in accordance with principles of the disclosed subject matter. FIG. 8 is a front perspective view of the stand assembly 100, or device similar thereto, with the drawer removed, in accordance with principles of the disclosed subject matter.

The stand assembly 100 can be provided with an attachment assembly 130, which can be described as a rotation assembly or as a first rotation assembly 130. The attachment assembly 130 can include a recessed center platform, boss or recessed boss 132. The recessed center platform 132 can engage with or mate with a mating attachment boss, bump boss, raised boss, or “protuberance boss” 182 (of an attachment assembly 180) on a back surface of the platform assembly 150. The attachment assembly 180, of the platform assembly 150, can be described as a rotation assembly or as a second rotation assembly 180. Accordingly, the raised portion 182 can be provided on the back of the platform assembly 150 that engages or mates with the recessed portion 132 of the stand assembly 100. Such structure could be reversed such that the platform 150 includes a recessed portion and the stand assembly 100 includes the raised portion. In general, the various engagement surfaces, as described herein, including raised portions that engage with respective recessed portions may be reversed (or “flipped”) on the respective components, as may be desired.

The recessed center platform 132 can be provided with an opening, hole, or aperture 134 in the center. An insert with a threaded hole can be disposed in such hole in the stand assembly 100. The insert with threaded hole can be integrated into the recessed center platform 132, i.e. in the back of the stand assembly 100 as shown in FIG. 6, in the molding process of the stand assembly 100, in at least one embodiment of the disclosure. The insert can be a heat set threaded insert.

As shown in FIG. 6, the insert can be in the form of a nut 133, with threaded hole 133TH that is received into an enlarged, shaped portion of the aperture 134 (see FIG. 6), with such enlarged, shaped portion being shaped to match the nut, e.g. hex shaped.

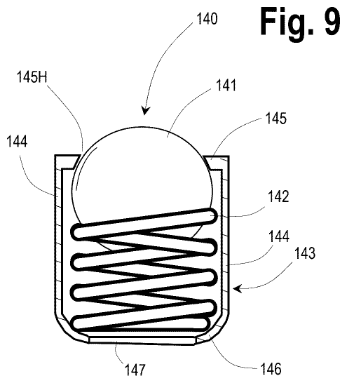

The recessed center platform 132 can also include or house a plurality of ball plungers or protuberances 140, i.e. ball plunger assemblies 140 shown in FIGS. 8 and 9, (in holes 136) that are spaced about the recessed center platform 132. For example, there can be four ball plungers 140 in respective holes 136. The ball plungers 140 can engage with cavities, recesses or holes 185 (in the mating attachment boss 182 of the attachment assembly 180) in the platform assembly 150. More specifically, the recessed platform 132 (of the stand assembly 100) rotatably supports, receives, and engages with the mating attachment protuberance boss 182 of the platform assembly 150, with ball plungers 140 engaging with cavities 185, of the platform assembly 150. The ball plungers can be short nosed spring plungers, for example, or other type of ball plunger can be used as desired.

Such arrangement can resist rotation, by a user, until a certain degree of rotational force is applied to the platform assembly 150 relative to the stand assembly 100. Upon a sufficient application of force, the ball plungers 140 can “click” past the cavities 185. Each of the ball plungers 140 can then click into another respective cavity 185 so as to maintain the platform assembly 150 in a desired rotational position. For example, holes may be provided in the attachment assembly 180 every 45 degrees so as to allow for 45 degree adjustments, or in any other increment as desired.

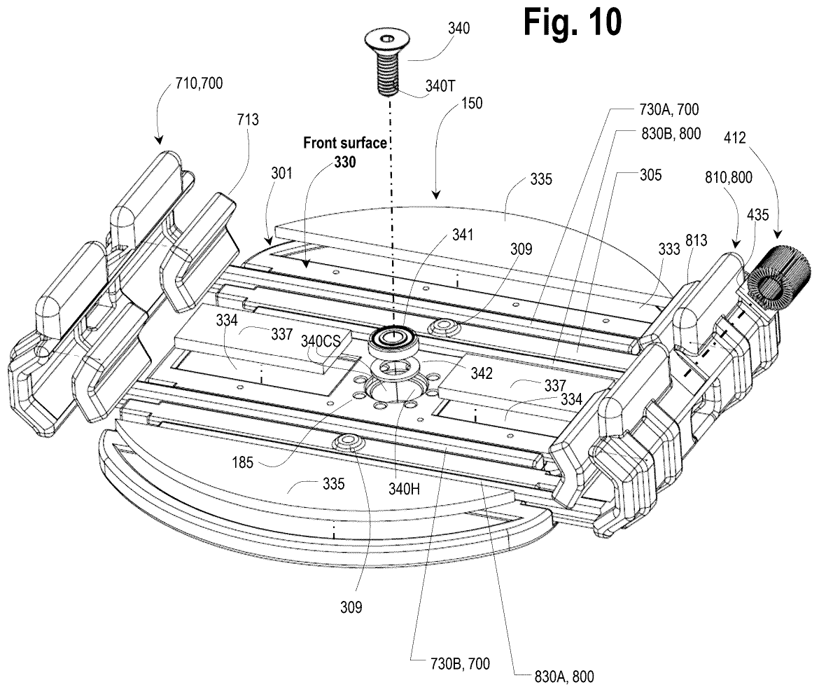

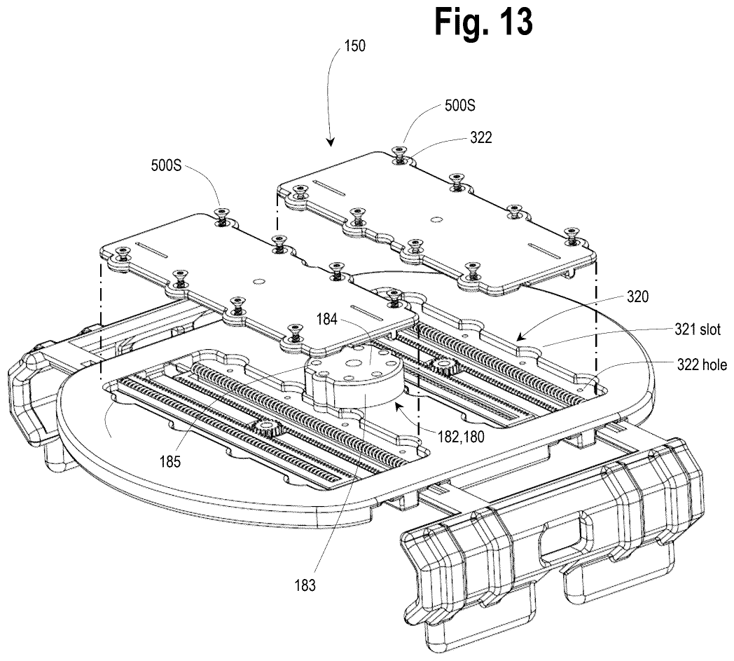

As described above, the platform assembly 150 can be rotatably mounted and supported on the stand assembly 100. Such rotation can be provided by the mating attachment boss 182 with outer surface 183 and lower surface 184 as shown in FIG. 13 (of the platform assembly 150) mated with the recessed center platform 132, as well as a suitable fastener such as a screw or bolt 340 (see FIG. 10), and other associated structure and components.

As described above, the stand assembly 100 can include a recessed center platform 132, which can also be described as a recessed boss 132. The recessed boss 132 can include a bottom surface 132B of the recess, as well as an interior side surface 132S, as shown in FIG. 5. The recessed boss 132 can accept and rotatably support the protuberance boss 182 of the platform assembly 150.

As described above, FIG. 5 shows details of the stand assembly 100. In particular, FIG. 5 shows a front face or top face 102 of a stand body portion 101 of the stand assembly 100. The stand assembly 100 can include a recessed, circular surface 119, which can provide surface to receive and/or to seat the platform assembly 150-so that the platform assembly can be rotated on the stand assembly 100. The stand assembly 100 can include the first rotation assembly 130. The first rotation assembly 130 engages with the second rotation assembly 180 as described above. The stand assembly 100 also includes the hinge barrels 111.

FIG. 6 shows a back face or bottom face 103 of the stand body portion 101. As shown, the stand assembly 100 can include a platform stopping boss 104. The platform stopping boss 104 can include an outer surface or curved surface 105. The platform stopping boss 104 can also include a lower flat surface 106. The surface 106 can engage with the base assembly 20 in a closed disposition or position of the support device 10. As shown in FIG. 6, the platform stopping boss 104 can include hole or recess 134 for insert 133, as well as holes 136 for ball plungers 140. As shown, the platform stopping boss 104 can be integrated with the construct of the recessed center platform 132.

Relatedly, FIG. 9 is a partial cross-sectional side view of a ball plunger assembly 140, in accordance with at least one embodiment. The ball plunger assembly or ball plunger 140 can include a ball 141 and spring 142. The ball 141 and spring 142 can be contained in a casing 143. The casing 143 can include sleeve 144. The casing 143 can include a ball retaining collar 145 that prevents the ball 141 from exiting from the casing 143. The ball retaining collar 145 can include an opening 145H into which the ball 141 can extend and into which the ball 141 can be biased by virtue of the force of the spring 142.

The casing 143 can also include a spring retaining collar 146. The spring retaining collar 146 can include opening 147. For example, the ball plunger 140 might be assembled by inserting both the ball 141 and the spring 142 into the casing 143, and then crimping the end of the casing so as to form the spring retaining collar 146. A ball plunger 140 can be inserted into, or molded into, a respective ball plunger hole 136, as shown in FIG. 6, for example. The balls 141 of each ball plunger 140 can be received into respective cavities 185 (of the platform assembly 150) so as to selectively allow rotation of the platform assembly 150 as described herein.

The platform assembly 150 can include the second rotation assembly 180. FIG. 13 shows details of the second rotation assembly 180 including an outer surface 183 of the protuberance boss 182. The second rotation assembly 180 can be received into the first rotation assembly 130, so as to allow rotation of the platform assembly 150 relative to the stand assembly 100. The screw 340, with threads 340T, can serve to attach the platform assembly 150 onto the stand assembly 100.

Hereinafter, further details will be described regarding the platform assembly 150. FIGS. 10-14 show the platform assembly 150, in accordance with at least one embodiment of the disclosed subject matter.

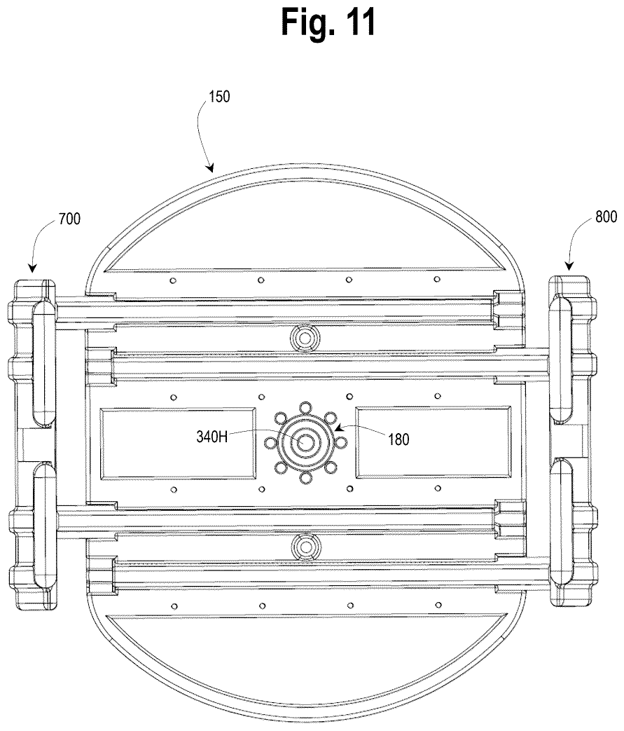

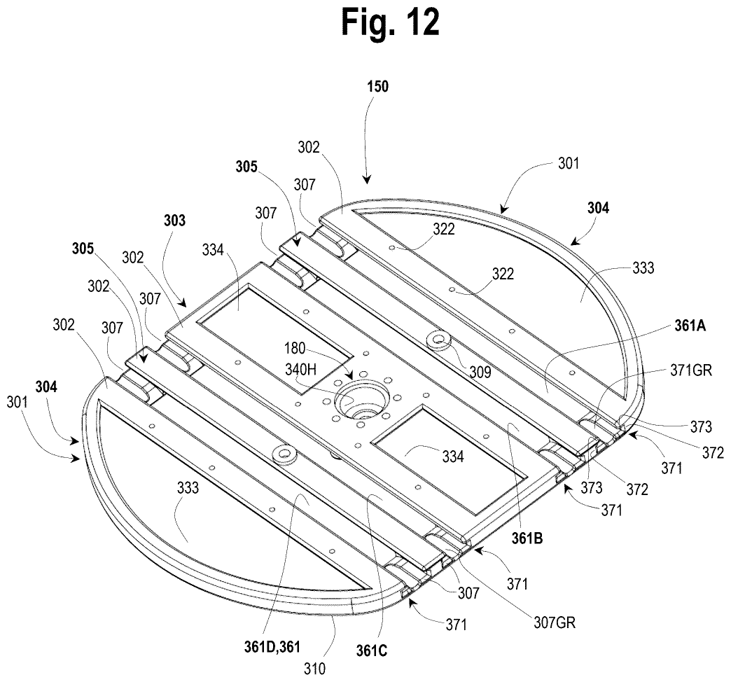

As described above, FIG. 10 is a top perspective of the platform assembly 150. FIG. 11 is a top view of a platform assembly of FIG. 10, or device similar thereto.

As described below, the platform assembly 150 can include or be associated with a left gripper assembly 700 and a right gripper assembly 800. The left gripper assembly 700 can include left device gripper(s) 710, i.e. left grippers 710, which can be described as a first gripper or left gripper. The right gripper assembly 800 can include right device grippers 810, i.e. right grippers 810, which can be described as a second gripper or right gripper.

Through mechanism described herein, the left gripper assembly 700 and the right gripper assembly 800 can be retracted into a body portion, body or gearbox 301 of the platform assembly 150. In other words, through retraction of the gripper assemblies 700, 800, a tablet can be held and secured onto the platform assembly 150. More specifically, a cell phone or other user device can be “clamped”between the left device grippers 710 and the right device grippers 810.

It is appreciated that the support device 10 of the disclosure is described in the context of use with a tablet. However, it is appreciated that any other user device (such as a cell phone) or other object can be used in conjunction with the support device 10, in its various embodiments, as may be desired.

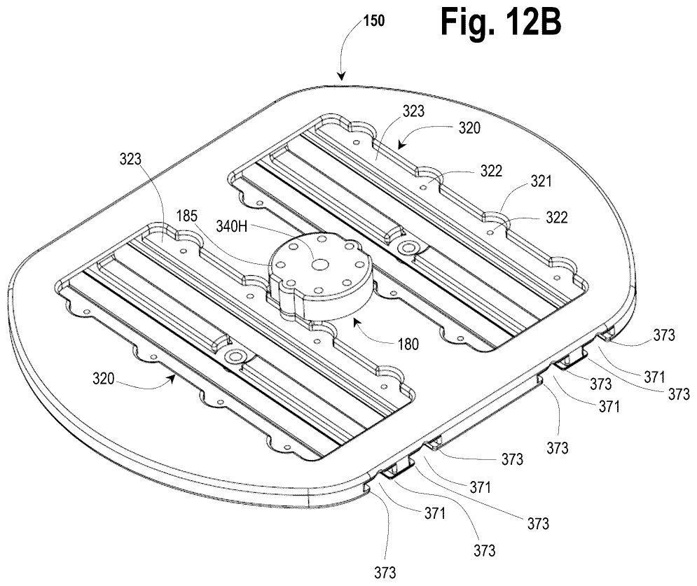

Relatedly, FIG. 12 is a front perspective view of the platform assembly 150, without the gripper assemblies 700, 800. As shown in FIG. 12, the platform assembly 150 can include a body portion 301. The body portion 301 can also be described as a gearbox 301. The body portion 301 can include and/or provide a casing 302. The casing 302, of the body portion 301, can include various walls, partitions, compartments, cavities, operational structure, operational supporting structure and other structure that can support the various working components of the platform assembly 150. The body portion or gearbox 301, and in particular the casing 302, can receive the left gripper assembly 700 and the right gripper assembly 800 therein, as described below.

FIG. 13 is an exploded, back perspective view of the platform assembly 150, showing gearbox covers 500 spaced from the body portion 301. FIG. 14 is a back view of the platform assembly 150 showing gearbox covers 500 removed from the body portion 301. FIG. 14B is a bottom, inner perspective of the gearbox cover 500, which is described below.

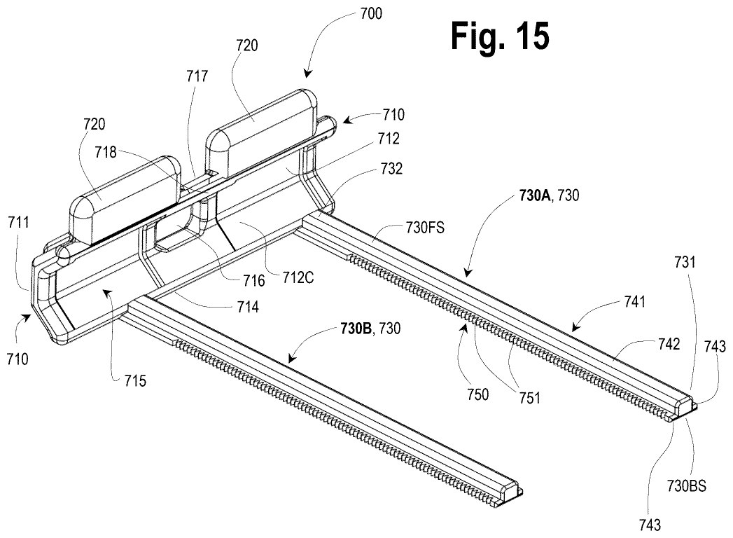

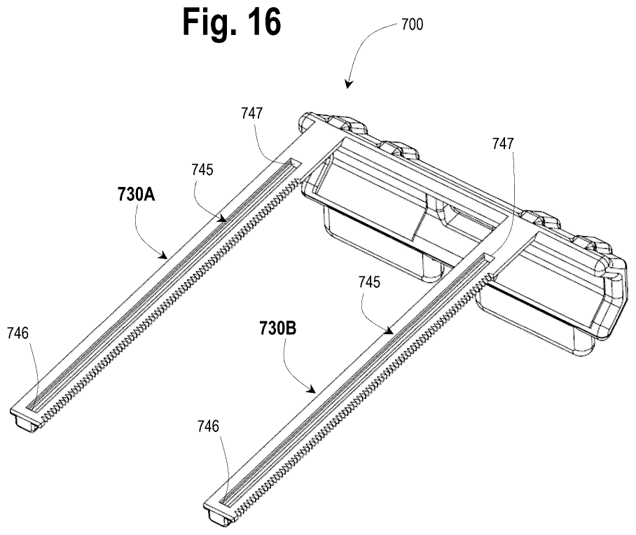

FIG. 15 is a top perspective view of a left gripper assembly 700, in accordance with at least one embodiment of the disclosed subject matter. FIG. 16 is a bottom perspective view of the left gripper assembly 700 of FIG. 15, or similar thereto, in accordance with principles of the disclosure.

The left gripper assembly 700 and the right gripper assembly 800, in accordance with at least one embodiment of the disclosed subject matter, can be the same, i.e. identical, or similar structure. That is, the left gripper assembly (i.e. a first gripper assembly) and the right gripper assembly (i.e. a second gripper assembly) can be of the same construct so as to be interchangeable. Further, all four of the support rods, of the left gripper assembly 700 and the right gripper assembly 800 can be the same or similar structure.

The left gripper assembly 700 can include a pair of left support rods 730, i.e. left support rods 730. The left support rods 730 can include a first left support rod 730A and a second left support rod 730B.

Each of the left support rods 730A and 730B can be of similar or same structure, as is shown in FIG. 15. In particular, in accordance with at least one embodiment of the disclosed subject matter as shown, the gears of a gear rack can be on the same side of both the first left support rod 730A and the second left support rod 730B.

With reference to FIGS. 14 and 15, for example, the first left support rod 730A can include a gear rack 750 with gears 751. The gear rack 750 can be described as a timing gear rack 750, with gears 751. The left timing gear rack 750 can be engaged with teeth of a first timing gear 311A. The first timing gear 311A can be positioned in a respective cavity 313A of the casing 302, as shown in FIG. 14, for example. The first left support rod 730A can be disposed in a first slide channel 361A, i.e. a slide channel 361A, in the casing 302.

The first left support rod 730A can include an outer end 731 and a connected end 732. The connected end 732 can be connected to and supported by the left gripper 710 (see FIGS. 14, 15). The left gripper 710 can be curved, so as to curve about, i.e. be concave about, a supported user device, and include a layer or cushion of foam or rubber padding 713 (see FIG. 10 e.g.) so as to support such user device. Structure of the left gripper and the right gripper is described above. With further reference to FIG. 15, the first left support rod 730A can include a back side 730BS and a front side 730FS. As shown in FIGS. 14, 15 and 16. The back side 730BS can include a spring channel 745. The spring channel 745 can house a spring 760. The spring channel 745 can have an abutment end 746 (that abuts a moving end 761 of the spring 760) and an empty end 747. The spring channel 745 can run along a substantial portion of the length of the first left support rod 730A.

The front side 730FS, of the first left support rod 730A (of the pair of support rods 730), can include and/or be constituted by a rail 741. The rail 741 can include a raised elongated rib 742 and opposing elongated flanges 743 that extend along the length of the first left support rod 730A. That is, the flanges 743 can be on opposing sides of the rib 742. The flange 743 that is inboard, as shown in FIG. 14 (also see FIG. 15), can include, be integrated with and/or support the gear rack 750.

Note in FIG. 14, the left gripper assembly 70 is positioned on the right of the platform assembly as compared to FIG. 11, for example, i.e. since the platform assembly is flipped over.

Relatedly, the platform assembly 150 can be provided with a first slide channel 361A (see FIG. 14). The first slide channel 361A (of the platform assembly 150) can include opposing rail slots 371 (see FIG. 12) that run along the length of the first slide channel 361A. The rail slots 371 can include a side wall 372 and a retaining flange 373. The opposing rail slots 371 can receive the flanges 743 of the first left support rod 730A.

With reference to FIGS. 14 and 15-16, the spring 760 (of the first left support rod 730A) biases the left gripper assembly 700 to a closed position. More specifically, the spring 760 can include the moving end 761 shown in FIG. 14 (i.e. moving in that it moves with the gripper) that is abutted against the abutment end 746 of the spring channel 745. The spring 760 can include a static end 762. The static end 762 can be abutted against a stop tab 521 (see FIG. 14B) of the cover 500.

Relatedly, the spring 760 is shown in a disposition in FIG. 14 “as if” the cover 500 were in place, and the stop tab 521 was abutted against the spring 760. As the left gripper 730 is pulled out (i.e. pulled left in FIG. 14) from the body of the platform assembly 150, the spring 760 is further compressed, thus biasing the left gripper 730 back to a more closed position, i.e. back to the right.

The first left support rod 730A is slidably held in place in the platform assembly 150. That is, the first left support rod 730A (and specifically the flanges 743 of the first left support rod 730A) are “sandwiched” between the cover 500 and the retaining flanges 373 of the first slide channel 361A (see FIG. 12 and FIG. 12B) of the casing 302 of the body portion 301. As shown in FIG. 12, the first slide channel 316, as well as the other slide channels are “seeable through” when the cover 500 is removed, as is shown in FIG. 12, as well as in FIG. 12B.

With further reference to FIGS. 14 and 15-16, for example, the second left support rod 730B (shown in the bottom right of FIG. 14) can be slidably disposed in a third slide channel 361C of the platform assembly 150, and the second left support rod engageable with the timing gear 311B. The arrangement and construct of the second left support rod 730B vis-á-vis the casing 302, of the body portion 301, can be same or similar to the first left support rod 730A.

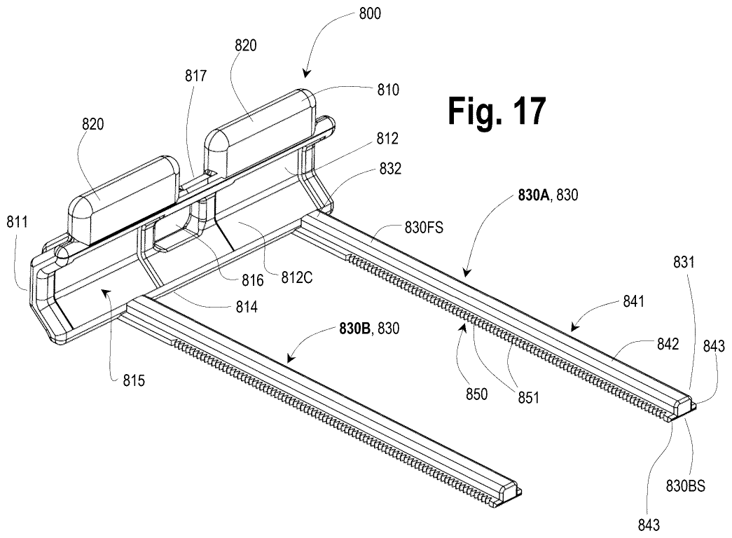

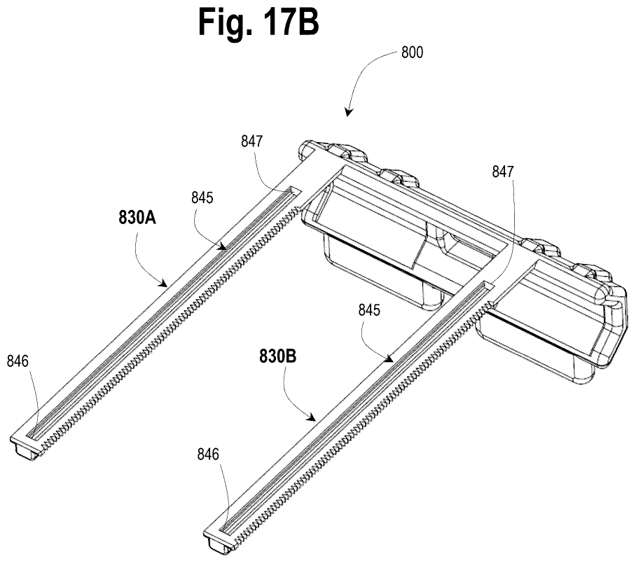

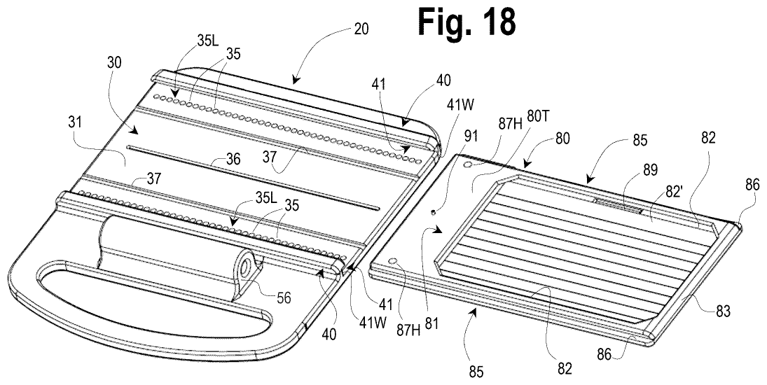

FIG. 17 is a top perspective view of the right gripper assembly 800, in accordance with at least one embodiment of the disclosed subject matter. FIG. 17B is a bottom perspective view of the right gripper assembly 800 of FIG. 15, or similar thereto, in accordance with principles of the disclosure. The right gripper assembly 800 can be the same as or similar to the construct of the left gripper assembly 700. For purposes of reference and explanation in this disclosure, the right gripper assembly is hereinafter described with reference to FIGS. 17 and 18.

The right gripper assembly 800 can include a pair of right support rods 830, i.e. right support rods 830. The right support rods 830 can include a first right support rod 830A and a second right support rod 830B.

Each of the right support rods 830A and 830B can be of similar or same structure, as is shown in FIG. 17. In particular, in accordance with at least one embodiment of the disclosed subject matter as shown, the gears of a gear rack can be on the same side of both the first right support rod 830A and the second right support rod 830B.

With reference to FIGS. 14 and 17, for example, the first right support rod 830A can include a gear rack 850 with gears 851. The gear rack 850 can be described as a timing gear rack 850, with gears 851. The timing gear rack 850 can be engaged with teeth of a second timing gear 311B (see FIG. 14). The second timing gear 311B can be positioned in a respective cavity 313B of the casing 302, as shown in FIG. 14, for example. The first right support rod 830A (see FIG. 14) can be disposed in a fourth slide channel 361D, i.e. a slide channel 361D, in the casing 302. The first right support rod 830A can include an outer end 831 and a connected end 832. The connected end 832 can be connected to and supported by the right gripper 810 (see FIGS. 14, 15). The right gripper 810 can be curved, so as to curve about, i.e. be concave about, a supported user device, and include a layer or cushion of foam or rubber padding 813 (see FIG. 10 e.g.) so as to support such user device. Structure of the right gripper and the left gripper is described above. With further reference to FIG. 17, the first right support rod 830A can include a back side 830BS and a front side 830FS. As shown in FIGS. 14, 17 and 18. The back side 830BS can include a spring channel 845. The spring channel 845 can house a spring 860. The spring channel 845 can have an abutment end 846 (that abuts a moving end 861 of the spring 860) and an empty end 847. The spring channel 845 can run along a substantial portion of the length of the first right support rod 830A.

The front side 830FS, of the first right support rod 830A (of the pair of support rods 830), can include and/or be constituted by a rail 841. The rail 841 can include a raised elongated rib 842 and opposing elongated flanges 843 that extend along the length of the first right support rod 830A. That is, the flanges 843 can be on opposing sides of the rib 842. The flange 843 that is inboard, as shown in FIG. 14 (also see FIG. 15), can include, be integrated with and/or support the gear rack 850.

Note in FIG. 14, the right gripper assembly is positioned on the left of the platform assembly as compared to FIG. 11, for example, i.e. since the platform assembly is flipped over.

Relatedly, the platform assembly 150 can be provided with a fourth slide channel 361D (see FIG. 14). The fourth slide channel 361D (of the platform assembly 150) can include opposing rail slots 371 (see FIG. 12) that run along the length of the fourth slide channel 361D. The rail slots 371 can include a side wall 372 and a retaining flange 373. The opposing rail slots 371 can receive the flanges 843 of the first right support rod 830A.

With reference to FIGS. 14 and 17-18, the spring 860 (of the first right support rod 830A) biases the right gripper assembly 800 to a closed position. More specifically, the spring 860 can include the moving end 861 shown in FIG. 14 (i.e. moving in that it moves with the gripper) that is abutted against the abutment end 846 of the spring channel 845. The spring 860 can include a static end 862. The static end 862 can be abutted against a stop tab 521 (see FIG. 14B) of the cover 500.

Relatedly, the spring 860 is shown in a disposition in FIG. 14 “as if” the cover 500 were in place, and the stop tab 521 was abutted against the spring 860 of the first right support rod 830A. As the right gripper 830 is pulled out (i.e. pulled left in FIG. 14) from the body of the platform assembly 150, the spring 860 is further compressed, thus biasing the right gripper 830 back to a more closed position, i.e. back to the right.

The first right support rod 830A is slidably held in place in the platform assembly 150. That is, the first right support rod 830A (and specifically the flanges 843 of the first right support rod 830A) are “sandwiched” between the cover 500 and the retaining flange 373 of the fourth slide channel 361D (see FIG. 12 and FIG. 12B) of the casing 302 of the body portion 301. As shown in FIG. 12, the first slide channel 316, as well as the other slide channels are “seeable through” when the cover 500 is removed, as is shown in FIG. 12, as well as in FIG. 12B.

With further reference to FIGS. 14 and 15-16, for example, the second right support rod 830B (shown in the top left of FIG. 14) can be slidably disposed in a second slide channel 361B of the platform assembly 150, and the second right support rod engageable with the timing gear 311A. Accordingly, movement of the first left support rod 730A can be mechanically tied to movement of the second right support rod 830B, via timing gear 311A. Further, movement of the second left support rod 730B can be mechanically tied to movement of the first right support rod 830A, via timing gear 311B, as is shown in FIG. 14.

As described above, the arrangement and construct of the second right support rod 830B vis-á-vis the casing 302, of the body portion 301, can be same or similar to the first right support rod 830A.

With reference to FIGS. 14, 16 and 17B, the first right support rod 830A can be slidably disposed in a fourth slide channel 361D of the platform assembly 150. The arrangement and construct of the first right support rod 830A vis-á-vis the casing 302, of the body portion 301, can be same of similar to the first left support rod 730A.

With reference to FIGS. 14, 16 and 17B, the second right support rod 830B can be slidably disposed in a second slide channel 361B of the platform assembly 150. The arrangement and construct of the second right support rod 830B vis-á-vis the casing 302, of the body portion 301, can be same of similar to the second left support rod 730B.

Note, in the arrangement of FIG. 14, the left gripper assembly 700 and the right gripper assembly 800 can be identical structure, but are flipped 180 degrees to each other as shown in FIG. 14.

As described above, the body portion or gearbox 301, and in particular the casing 302, can receive the left gripper assembly 700 and the right gripper assembly 800 therein, as described below. The casing can include a center portion or center member 303; opposing outer portions or outer members 304; and opposing separator bridges 305. A separator bridge 305 can be positioned between the central member, center member, central portion or center portion 303 and a respective outer portion 304. The spacing between such components can provide the slide channels 361, which include the side channels 361A, 361B, 361C, 361D, as shown in FIG. 12.

Further, a plurality of connectors or connector members 307 ( i.e. in total eight (8) connector members can serve to connect the center portion 303, the outer portions 304, and the separator bridge 305. Each of the connectors 307 can include a groove or relief groove 307GR. Such relief groove 307GR can provide clearance so that the support rods, of the grippers, don't “catch” on the connectors 307.

As shown in FIG. 12, each of the separator bridges 305 can include a boss or hole 309. The hole 309 can serve to support a pin upon which a respective timing gear (311A or 311B) can be mounted.

The body portion 301 can include a back surface 310 and a front surface 330. The front surface 330, as shown in FIG. 12, can include opposing outboard trays 333. The front surface 330 can also include inboard trays 334. The outboard trays 333 can support a respective outboard cushion 335, as shown in FIG. 10. The inboard trays can support a respective inboard cushion 337. The cushions can serve to support and grip a user device mounted on the support device 10. As shown in FIG. 10, a screw 340 can be received into a screw hole 340H so as to secure the platform assembly 150 onto the stand assembly 100. The tightness of the screw can be adjusted by a user so as to adjust how hard it is to rotate the platform assembly or platform 150 upon the stand assembly or stand 100. A roller bearing 341 with washer 342 can be provided in conjunction with the screw or bolt 340 so as to assist in smooth rotation of the platform upon the stand. The screw hole 340H can be provided with one or more countersink(s) or counterbore(s) 340CS so as to receive the washer and/or the roller bearing 341, or for aesthetic appearance.

FIG. 12B is a back perspective view of the platform assembly of FIG. 1, or device similar thereto, without the gripper assemblies, in accordance with principles of the disclosure. FIG. 12 shows structure of the attachment assembly 180, including hole 340H. FIG. 12B also shows gearbox cavities 320. Each of the gearbox cavities 320 can house a respective timing gear. Each gearbox cavity 320 can include flats 323 upon which a cover 500 can be supported, attached via screw holes 322, which accept screws 500S. Slots 321 can be provided to mate with corresponding structure in the cover 500, so as to correctly position and orient the cover 500 on the platform assembly 150.

FIG. 14 shows timing gear 311A. Operation of the timing gear so as to sink or synchronize the grippers or gripper assemblies 700, 800 are described above. The timing gear 311A can include a hole or bore, so as to mount the timing gear. The timing gear 311A can be received into a cavity 313A in a corresponding separator bridge 305. The timing gear 311A can be rotatably supported upon a pin 314A. The pin 314A can be supported by the boss or hole 309 in a corresponding separator bridge 305 and by a corresponding boss or hole 520 in a corresponding gearbox cover or cover 500.

FIG. 14 shows timing gear 311B. Operation of the timing gear so as to sink or synchronize the grippers or gripper assemblies 700, 800 are described above. The timing gear 311B can include a hole or bore, so as to mount the timing gear. The timing gear 311B can be received into a cavity 313B in a corresponding separator bridge 305. The timing gear 311B can be rotatably supported upon a pin 314B. The pin 314B can be supported by the boss or hole 309 in a corresponding separator bridge 305 and by a corresponding boss or hole 520 in a corresponding gearbox cover or cover 500.

FIG. 14B is a back perspective view of a gearbox cover or cover 500. Both of the gearbox covers 500 mounted on the body portion 301 of the platform assembly 150 can be the same or similar structure. The gearbox cover 500 can include a plurality of holes 500H to receive screws 500S so as to mount the cover onto the body 301. The screws 500S can be threaded into or screwed into the body portion 301. Each of the covers 500 can serve to contain and keep in place both the timing gears 311A and 311B and to keep in place and contain the support rods or gripper support rods 730. The cover 500 can include a notch or slot 500SL to wrap around or encircle a side bump of the attachment assembly 180. FIG. 14C is a perspective view of an outer surface of the gearbox cover shown in FIG. 13, or cover similar thereto, in accordance with principles of the disclosure.

Each of the two covers 500 can be of similar or same construct. The cover 500 can include an outer surface 501 and an inner surface 510. The inner surface 510 can include the boss or hole 520 for a respective pin 314A, 314B. As otherwise described herein, the cover 500 can include a respective spring tab or engagement tab 521 near opposing corners of the cover 500 as shown in FIG. 14B. As described herein, a corresponding spring can abut against or be positioned against a spring tab 521. Accordingly, an end of the spring that abuts against the spring tab 521 can be described as a static end of the spring. On the other hand, the end of the spring that moves with the particular support rod (being contained within a spring channel 745) can be described as a moving and/or dynamic end of the spring. It is this movement or compression of the spring that causes the gripper assemblies 700, 800 to be biased towards the closed position. Relatedly, the cover 500 can be provided with a spring seating channel 505. The spring seating channel 505 can be in the form of a groove, slot or channel that serves to partially receive and or “seat” a spring therein. Accordingly, a spring can be contained or sandwiched between the cover 500 and a corresponding spring channel 745 of one of the support rod 730.

Relatedly, the cover 500 can be provided with a respective slot 502, for each of the spring tabs or engagement tabs 521. The slot 502 can be provided for placement of a spring in assembly or manufacture of the support device 10, i.e. and in particular the slot 502 can be used specifically with the mounting of the cover 500 onto the body portion 301. That is, in assembly or mounting of the cover 500 onto the body or body portion 301 a user can extend a small pin or other tool (akin to a paperclip or other pin) through the slot 502 so as to engage with the contained spring. The user then can manipulate or compress the spring so that the spring tab 521 (of the cover 500) “clears” the spring in mounting of the cover 500 onto the body 301. Such operation can be done for both of the springs using both of the slots 502 in the cover 500. Accordingly, without the slots 502, a spring might be incorrectly positioned so as to interfere or engage with the spring tab 521 in mounting of the cover onto the body 301. Such incorrect positioning could result in a spring being crushed between a spring tab 521 and a spring channel 745 in mounting of the cover upon the body 301.

Accordingly, in the arrangement described above (see in particular FIG. 14), the gear rack 750 (of support rod 730A) is engaged with timing gear 311A, and timing gear 311A is engaged with the gear rack 850 (of support rod 830B). In similar manner, the gear rack 750 (of support rod 730B) is engaged with the timing gear 311B, and timing gear 311B is engaged with gear rack 850 (of the support rod 830A).

Accordingly, movement of the left gripper assembly 700 is mechanically tied to movement of the right gripper assembly 800 so that the grippers 710 and 810 move in concert or unison, but in opposite directions. That is, as the left gripper assembly 700 goes left, the right gripper assembly 800 goes right (under the force of a user applying pressure to the gripper assemblies 699), i.e. so as to open the gripper assemblies 699—so as to spread the grippers, to insert a user device into the support device 10 (see FIG. 10 for example). On the other hand, in a closing operation, as the left gripper assembly 700 goes right, the right gripper assembly 800 goes left (under the biasing force of springs), i.e. the gripper assemblies 699 are biased to a closed position.

FIGS. 10 and 15, for example, illustrates the structure of the left gripper assembly 700 and the right gripper assembly 800. The left gripper assembly 700 and the right gripper assembly 800 can be of similar or same construct.

The left gripper assembly 700 can include an outer face 711 and an inner face 712. The inner face 712 can form or define a cavity 712C. The cavity 712C can serve to retain or hold a user device, such as a smart phone. As described above, a cushion 713 can be mounted upon or attached onto the inner face 712. Each left gripper 710 can also include a connection edge 714 that attaches the left gripper 710 onto the left support rods 730A, 730B.

With further reference to FIG. 15, the left gripper assembly 700 can include a core body or body 715, which can include an opening 716. Relatedly, a connection member 718 can extend across the opening 716 and/or define the opening 716, to provide structural strength and rigidity. Accordingly, the connection member 718 can extend between extension fingers 720.

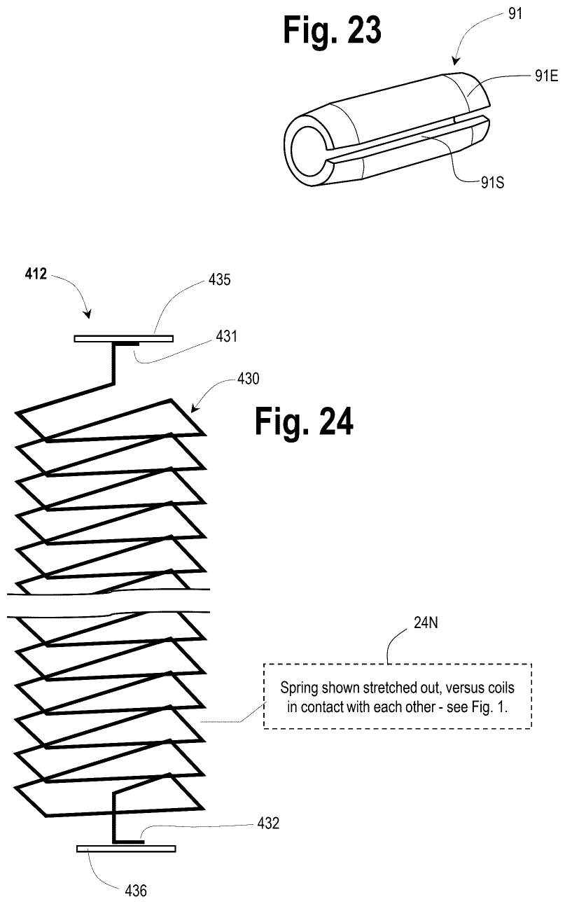

The opening 716 can provide access to a supported user device, so as to insert a charge cable into a bottom port of the supported user device. The connection member 718 can include a flat surface, rounded surface, or attachment surface 717 to which a stylus holder can be attached, as described herein. That is, plates 435 of a stylus holder 412 (see FIG. 24) can be attached to the attachment surface 717 in some mechanical manner, such as by adhesive, screw(s), and/or by bonding/integrating the plates 435 to the gripper 710 in a molding process to manufacture the gripper assembly 700. Accordingly, a stylus holder 412 can be attached to the platform assembly as shown in FIG. 1, in accordance with at least one embodiment of the disclosed subject matter.

The right gripper assembly 800 can include an outer face 811 and an inner face 812. The inner face 812 can form or define a cavity 812C. The cavity 812C can serve to retain or hold a user device, such as a smart phone. As described above, a cushion 813 can be mounted upon or attached onto the inner face 812. Each right gripper 810 can also include a connection edge 814 that attaches the right gripper 810 onto the right support rods 830A, 830B.

With further reference to FIG. 17, the right gripper assembly 800 can include a core body or body 815, which can include an opening 816. Relatedly, a connection member 818 can extend across the opening 816 and/or define the opening 816, to provide structural strength and rigidity. Accordingly, the connection member 818 can extend between extension fingers 820.

The opening 816 can provide access to a supported user device, so as to insert a charge cable into a bottom port of the supported user device. The connection member 818 can include a flat surface, rounded surface, or attachment surface 817 to which a stylus holder can be attached, as described herein. That is, plates 435 of a stylus holder 412 (see FIG. 24) can be attached to the attachment surface 817 in some mechanical manner, such as by adhesive, screw(s), and/or by bonding/integrating the plates 435 to the gripper 810 in a molding process to manufacture the gripper assembly 800. Accordingly, a stylus holder 412 can be attached to the platform assembly as shown in FIG. 1, in accordance with at least one embodiment of the disclosed subject matter. The right gripper assembly 800 can include extension fingers or members 820 that can be provided to further “wrap-around”and enclose a user device.

The left gripper assembly 700 can include extension fingers or members 720 that can be provided to further “wrap-around” and enclose a user device. The left gripper assembly 700 and the right gripper assembly 800 can be of similar or same construct.

As described above, FIG. 3 is a top perspective view of the base assembly with sliding drawer 80 or drawer 80 pulled out. Relatedly, FIG. 18 is a top perspective of the base assembly with drawer 80 pulled out, with an “index card” or card 82′positioned in the drawer 80. Further details of the drawer 80 and the structure of the base assembly 20, which receives the drawer 80, will be described below, with reference to FIG. 18. The drawer 80 can include a top surface 80T and a bottom surface 80B.

As described herein, the base assembly 20 can include the sliding drawer 80. It is appreciated that the dimensions and geometry of the sliding drawer 80 can be varied as desired. In general, it is appreciated that the dimensions of the various components of the support device as described herein can be varied as desired. For example, the width, depth, and height dimensions of a component described herein can be varied as desired.

As shown in FIG. 18, the base assembly 20 includes a receiving cavity 30 for the drawer 80. The receiving cavity 30 can include a receiving cavity surface 31 that provides a top facing surface. The drawer 80 can be slidably received into the receiving cavity 30 and onto the receiving cavity surface 31.

The base assembly 20 can include edge support portions 40, which can extend across the base assembly 20. Each edge support portion 40 can include drawer grooves or slots 41 that extend horizontally outboard of the receiving cavity 30, i.e. the slots 41 can extend laterally across the base assembly 20, in the embodiment of FIG. 18. The drawer grooves 41 serve to accept rails, side slide rails or side rails 86 of a sliding drawer member 80 or sliding drawer 80. As shown in FIG. 18, an outboard extent of each drawer groove 41 can be defined by opposing groove outboard walls 41W, which are of wider width than the sliding drawer 80, so as to accommodate the sliding drawer 80 therebetween. Accordingly, the sliding drawer 80 can be slidably received into the drawer grooves 41.

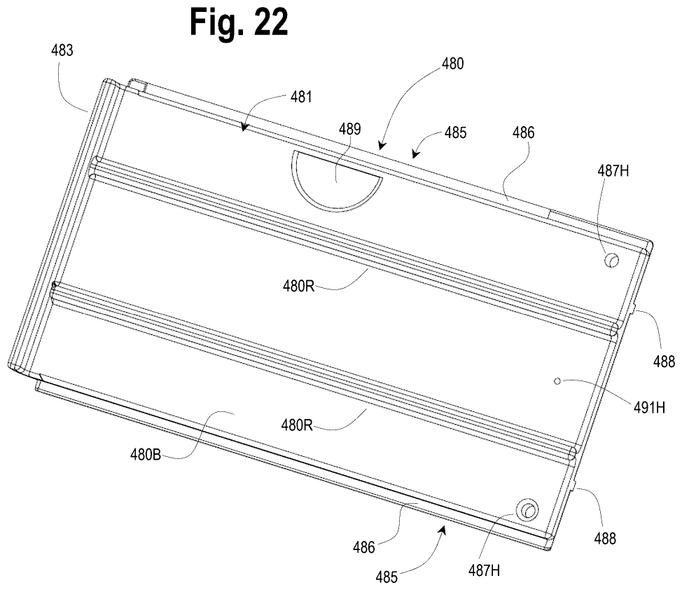

The base assembly 20 can include one or more travel limiting grooves 36. The travel limiting grooves 36 can accommodate a respective travel pin(s) 91 of the sliding drawer 80. The travel pin 91 can be a slotted spring pin, as shown in FIG. 23, with a slot 91S and beveled ends 91E. Accordingly, the travel limiting groove 36, in which a respective travel pin 91 slides, can limit the travel of the sliding drawer 80 from a fully extended position to a fully retracted position. The particular amount of travel allotted to the sliding drawer 80 can, accordingly, be controlled, i.e. limited, by the length of the travel limiting groove(s) 36. FIG. 23 is a perspective view of a travel pin 91, in accordance with at least one embodiment of the disclosed subject matter. The travel pin 91 can have a slit along one side, so as to compressible in diameter, to some extent. The travel pin 91 can have beveled ends, so as to easy insertion of the travel pin into a receiving aperture.

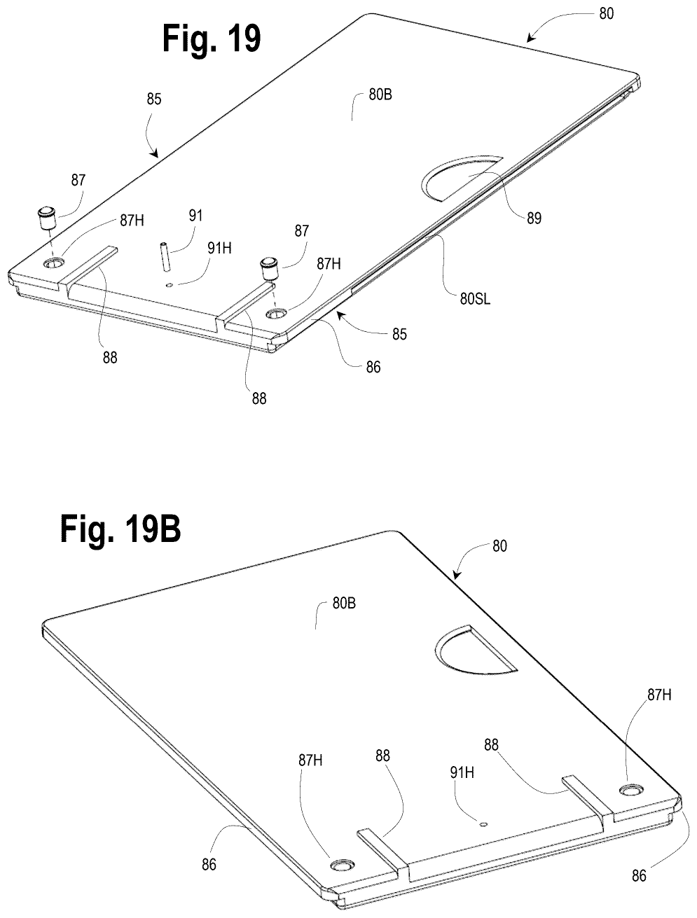

As shown in FIG. 18, the drawer 80 also includes drawer engagement knobs or bosses 87. Each of such bosses 87 can be in the form of a protuberance, bump, knob, ball plunger (as shown in FIG. 19), or other similar structure. Each boss 87 can engage with a corresponding line of holes 35L in the base assembly 20. The line of holes 35L includes a series of receiving holes or cavities 35. That is, as a user moves the sliding drawer 80 from a retracted position to an extended position, or vice versa, the boss 87, on each side, “clicks,” from one hole 35 to the next hole 35. A certain amount of resistance is required to “click” the boss 87 from one hole 35 to the next hole 35. Accordingly, due to such amount of resistance, the sliding drawer 80 can be retained in a desired position (with each boss 87 “nested” in a particular respective receiving hole or cavity 35, on each side of the sliding drawer 80) until the user applies sufficient force so as to further extend or retract the sliding drawer 80 in the base assembly 20, i.e. so as to “click” each boss 87 to the next hole 35.

As shown in FIG. 18, the base assembly 20 can also include a pair of slots 37. The drawer 80 can include a pair of ridges 88, as shown in FIG. 19. The ridges 88 can be slidably received into the slots 37. The ridges 88 received into the slots 37 can serve to keep the sliding drawer 80 aligned with the base assembly 20 and/or orient the sliding drawer 80 relative to the base assembly 20.

Accordingly, such construct can serve to prevent misalignment and “binding” as a user pulls out or pushes in the sliding drawer 80.

As shown in FIG. 18, the sliding drawer 80 can include a body 81. The body 81 can include a tray, cavity, or recess 82. The tray or cavity 82 can provide a space in which a notepad or card 82′or other item can be stowed. The tray 82 can be provided with an opening 89, which extends through the drawer 80, with the hole providing a way to “pop” an index card out when the index card is in the tray 82 The particular size of the tray 82 can be varied as desired. The sliding drawer 80 can include a pull tab or pull shoulder 83. The pull tab 83 can be grabbed onto by the user so as to manipulate the sliding drawer 80. The sliding drawer 80 can include side assemblies or side portions 85. The side portions 85 can include the side slide rails 86, rails, or outer rails 86. As described herein, each of the rails 86 can engage with a corresponding drawer groove 41, so as to slidably support the sliding drawer 80 within the base assembly 20. The size and geometry of the sliding drawer 80 and/or the base assembly 20 can vary as desired.

FIG. 19 is a bottom perspective view of the sliding drawer 80, in accordance with at least one embodiment of the disclosed subject matter. FIG. 19B is a further bottom perspective view of the sliding drawer 80. FIGS. 19 and 19B show in further detail the side slide rails or rails 86 of the sliding drawer 80 that engage with the base assembly 20. The rails 86 can be described as side slide rails, rails, slide rails, or outer rails, for example. FIG. 19 also shows the ridges 88 of the sliding drawer 80, which engage with the slots 37 of the base assembly 20. FIG. 19 shows the travel pin 91, in a hole 91H of the sliding drawer 80, that can engage with the travel limiting groove 36, of the base assembly 20, so as to limit travel of the sliding drawer 80 relative to the base assembly 20. FIG. 19 also shows slit 80SL, which can be used to insert and remove an index card or card from the sliding drawer 80.

FIG. 19 shows a boss(s) 87, i.e. a ball plunger(s) 87, in an exploded manner from a respective hole 87H of the sliding drawer 80, into which the boss or plunger 87 is received. Each of the bosses 87 can engage with respective line of holes 35L, of the base assembly 20, so as to restrain travel of the sliding drawer 80 relative to the base assembly 20.

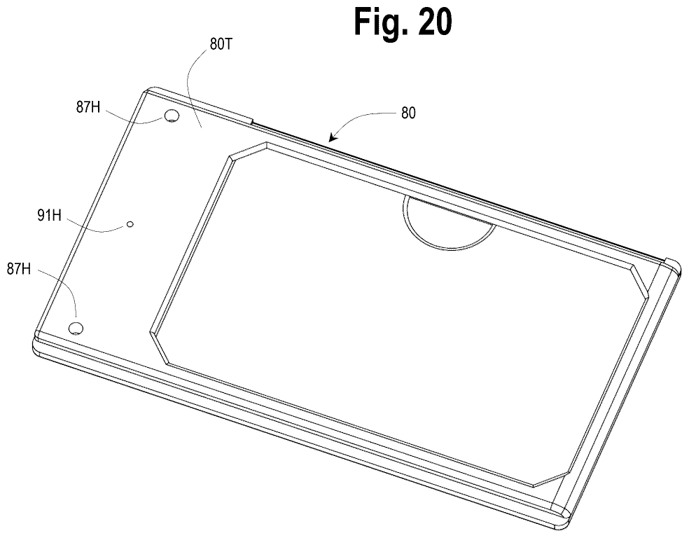

FIG. 20 is a top perspective view of the drawer 80 of the base assembly 20.

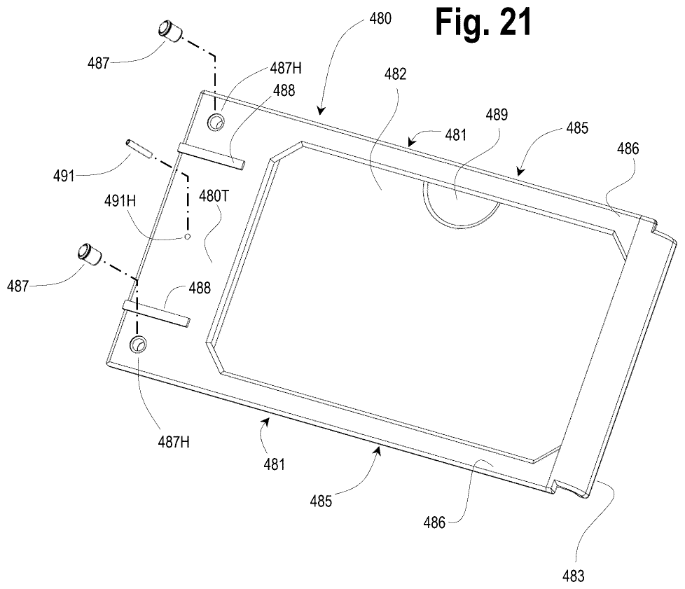

As described above, FIG. 6 is a back perspective view of the stand assembly 100. The stand assembly 100 can include a sliding drawer 480 or drawer 480, as shown in FIG. 2. Relatedly, FIG. 8 is a top perspective view of the stand assembly 100 with drawer 480 pulled out, in an exploded view, with an “index card” or card 482′positioned in a tray of the drawer 480. Further details of the drawer 480 and the structure of the stand assembly 100, which receives the drawer 480, will be described below, with reference to FIGS. 6 and 8, as well as FIGS. 21 and 22. The drawer 480 can include a top surface 480T and a bottom surface 480B.

As described herein, the stand assembly 100 can include the sliding drawer 480. It is appreciated that the dimensions and geometry of the sliding drawer 480 can be varied as desired. In general, it is appreciated that the dimensions of the various components of the support device as described herein can be varied as desired. For example, the width, depth, and height dimensions of a component described herein can be varied as desired.

As shown in FIG. 6, the stand assembly 100, and specifically the back surface 100BS of the stand assembly 100, can include a receiving cavity 230 for the drawer 480. The receiving cavity 230 can include a receiving cavity surface 231 that provides a back facing surface. The drawer 480 can be slidably received into the receiving cavity 230 and onto the receiving cavity surface 231. The stand assembly 100 can include edge support portions 240, which can extend across the stand assembly 100. Each edge support portion 240 can include drawer grooves or slots 241 that extend horizontally outboard of the receiving cavity 230, i.e. the slots 241 can extend laterally across the stand assembly 100, in the embodiment of FIG. 6. The drawer grooves 241 serve to accept rails, side slide rails or side rails 486 of the sliding drawer member, drawing or sliding drawer 480. As shown in FIG. 6, an outboard extent of each drawer groove 241 can be defined by opposing groove outboard walls 241W, which are of wider width than the sliding drawer 480, so as to accommodate the sliding drawer 480 therebetween. Accordingly, the sliding drawer 480 can be slidably received into the drawer grooves 241.

The stand assembly 100 can include one or more travel limiting grooves 236. The travel limiting grooves 236 can accommodate a respective travel pin(s) 491 (shown in FIG. 21) of the sliding drawer 480. The travel pin 491 can be a slotted spring pin, as shown in FIG. 23. Accordingly, the travel limiting groove 236 (of the stand assembly 100), in which a respective travel pin 491 slides, can limit the travel of the sliding drawer 480 from a fully extended position to a fully retracted position. The particular amount of travel allotted to the sliding drawer 480 can, accordingly, be controlled, i.e. limited, by the length of the travel limiting groove(s) 236.

As shown in FIGS. 8 and 21, the drawer 480 can also include drawer engagement knobs or bosses 487. Each of such bosses 487 can be in the form of a protuberance, bump, knob, ball plunger (as shown in FIG. 9), or other similar structure. Each boss 487 can engage with a corresponding line of holes 235L in the stand assembly 100. The line of holes 235L includes a series of receiving holes or cavities 235. That is, as a user moves the sliding drawer 480 from a retracted position to an extended position, or vice versa, the boss 487, on each side of the drawer, “clicks,” from one hole 235 to the next hole 235. A certain amount of resistance is required to “click” the boss 487 from one hole 235 to the next hole 235. Accordingly, due to such amount of resistance, the sliding drawer 480 can be retained in a desired position (with each boss 487 “nested” in a particular respective receiving hole or cavity 235, on each side of the sliding drawer 480) until the user applies sufficient force so as to further extend or retract the sliding drawer 480 in the stand assembly 100, i.e. so as to “click” each boss 487 to the next hole 235.

As shown in FIG. 6, the stand assembly 100 can also include a pair of slots 237. The drawer 480 can include a pair of ridges 488, as shown in FIG. 21 and FIG. 22. The ridges 488 can be slidably received into the slots 237. The ridges 488 received into the slots 237 can serve to keep the sliding drawer 480 aligned with the stand assembly 100 and/or orient the sliding drawer 480 relative to the stand assembly 100. Accordingly, such construct can serve to prevent misalignment and “binding”as a user pulls out or pushes in the sliding drawer 480.

As shown in FIGS. 8, 21 and 22, the sliding drawer 480 can include a body 481. The body 481 can include a tray, cavity, or recess 482. The tray or cavity 482 can provide a space in which a notepad or index card(s) 482′or other item can be stowed. The tray 482 can be provided with an opening or hole 489, which extends through the drawer 480, with the hole 489 providing a way to “pop” an index card out, with a user's finger, when the index card is in the tray 482. The particular size of the tray 482 can be varied as desired. The sliding drawer 480 can include a pull tab or pull shoulder 483, as shown in FIG. 8, for example. The pull tab 483 can be grabbed onto by the user so as to manipulate the sliding drawer 480. The sliding drawer 480 can include side assemblies or side portions 485. The side portions 485 can include the side slide rails 486, rails, or outer rails 486, or rails 486. As described herein, each of the rails 486 can engage with a corresponding drawer groove 241, so as to slidably support the sliding drawer 480 within the stand assembly 100. The size and geometry of the sliding drawer 480 and/or the stand assembly 100 can vary as desired.

FIG. 21 also shows the ridges 488 of the sliding drawer 480, which engage with the slots 237 of the stand assembly 100. FIG. 21 shows the travel pin 491, in a hole 491H of the sliding drawer 480, that can engage with the travel limiting groove 236, of the stand assembly 100, so as to limit travel of the sliding drawer 480 relative to the stand assembly 100. FIG. 21 shows boss(s) 487, for example a ball plunger 487, in an exploded manner from a respective hole 487H of the sliding drawer 480. Each of the bosses 487 can engage with respective line of holes 235L, of the stand assembly 100, so as to restrain travel of the sliding drawer 480 relative to the stand assembly 100.

Accordingly, FIG. 21 is a top perspective view of the sliding drawer 480 of the platform assembly 150, in accordance with at least one embodiment. FIG. 22 is a bottom perspective view of the sliding drawer 480 of the platform assembly 150, in accordance with at least one embodiment.

FIG. 22 shows in further detail the side slide rails or rails 486 of the sliding drawer 480 that engage with the stand assembly 100. The rails 486 can be described as side slide rails, rails, slide rails, or outer rails, for example. The rails 486 can be positioned along a side of the drawer 480. FIG. 22 also shows ridges 480R that run across at least a portion of the length of the drawer 480. The ridges 480R can be provided to provide structural strength and rigidity to the drawer 480. The ridges 480R can be provided to afford a tactile structure that a user can feel and interface with, so as to assist a user in physically manipulating and holding the drawer 480.

FIG. 24 is a schematic diagram of a coiled spring 430 that can provide the stylus holder 412 shown in FIG. 1, which can hold a stylus, such a pen, pencil or other stylus. As noted at 24N the spring in FIG. 24 is shown stretched out as compared to, in a normal operational state, the coils of the spring would be in contact. The spring 430 can be constructed of rectangular coiled spring as shown. That is, each coil of the spring 430 can be constructed in an elongated, rectangular shape. The particular shape can be varied as desired. The spring can be constructed of stainless steel, for example. In the schematic diagram of FIG. 24, the spring 430 is stretched out or elongated. In practice, in a stylus holder 412, the coils of the spring would preferably be in contact with each other, as noted above. Such arrangement is shown in FIG. 1 and in FIG. 2. The spring can include a first end 431 that is connected to a first plate 435. The spring can include a second end 432 that is connected to a second plate 436. To provide the stylus holder 412 shown in FIG. 1, the spring 430 can be formed into a circle with the first plate 435 and second plate 436 proximate or in contact with each other, such as in the configuration shown in FIG. 1. The plates 435, 436 can then be fastened into or onto the surface of the platform assembly 150, or other supporting surface, in some suitable manner. For example, the plates 435, 436 can be integrated into the platform 150 in an injection molding process of the platform assembly 150. In an embodiment, both ends of the spring 430 can be fastened onto the same plate. The fastening mechanism used to attach the spring to the plate can be, for example, a folded section of the plate that is crimped onto the end of the spring.

The inner diameter of the stylus holder 412 can be sized so as to be slightly smaller than a standard stylus, such as a pen or pencil. As a result, when the user inserts a pen into the holder 412, the holder slightly expands so as to snuggly hold the pen.

In the embodiment of FIG. 1, the stylus holder 412 can be positioned between two grippers, as otherwise described herein. However, the stylus holder 412 could be positioned at another location on the base assembly 20 or at or on another location on the support device described herein, as may be desired.

The support device 10 described herein can support a wide variety of electronic devices and objects. The support device 10 can support a smart phone or cell phone, a tablet, or other electronic device. The support devices of the disclosure can support an electronic device while providing various manipulation and positioning of the electronic device. As otherwise described herein, the platform assembly 150 can rotate so as to afford rotational adjustability, for example by 45 degree increments. Accordingly, a user device can be switched between landscape and portrait viewing easily, or at some increment in between, such as 45 degrees. The handles described herein can enhance manipulation of the support device 10 and can provide ease of carrying.

Hereinafter, further features of the disclosure will be described with reference to FIGS. 25-27, showing a support device in accordance with at least one embodiment of the disclosed subject matter.

FIG. 25 is a front partial perspective view of a support device 10, in accordance with principles of the disclosure. FIG. 26 is a side perspective view of the support device of FIG. 25, or device similar thereto, in accordance with principles of the disclosure.

FIG. 26B is a cutaway view of portion A of the support device of FIG. 26, in accordance with principles of the disclosure.

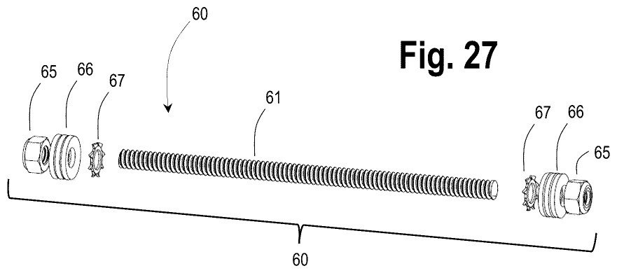

The support device 10, shown in FIG. 25, can include a base assembly 20, stand assembly 100, and platform assembly 150 similar or same in construct to that of FIG. 1. However, the support device 10 of FIG. 25 can include a different hinge pin assembly, i.e. hinge pin assembly 60 (see FIG. 27) versus the hinge pin assembly 70 as shown in FIGS. 1 and 7.

As described above, the stand assembly 100 (of FIG. 1 and FIG. 25) can include hinge structure so as to hingedly, pivotally, or pivotably attach to the base assembly 20. The base assembly 20 can include the hinge barrel assembly 50, as described above and as shown in FIGS. 1 and 2, in particular. The hinge barrel assembly 50 can include the hinge barrel 51.

The stand assembly 100 can include the hinge barrel assembly 110 The hinge barrel assembly 110 can include opposing hinge barrels 111. Each of the hinge barrels 111 can include hinge pin holes or bores 113. Each of the bores 113, of the stand assembly of FIG. 1 and FIGS. 25, 26 and 26B can be provided with a counterbore with counterbore surface 113CBS. Each of the bores 113 can house a pin, threaded pin, screw or bolt, of either the hinge pin assembly 60 (FIGS. 25-26B and 27) or the hinge pin assembly 70 (FIG. 1).

As described above, each of the opposing hinge barrels 111 can be of similar structure, but in mirror image of each other. Each hinge barrel 111 can include an inner contact face 114. The inner contact face 114 can be in frictional contact with a corresponding outer face or contact face 56 of hinge barrel 51. An amount of frictional force, resistant to rotation of the stand assembly 100 relative to the base assembly 20, can be adjusted.

That is, in the arrangement of FIG. 1, as the threaded pin 71 (described above) is tightened against the counterbore surface 113CBS, the frictional force between inner face 114 (of hinge barrel 111) and outer face 56 (of hinge barrel 51) is increased. Such variable resistance allows a user to adjust how easily the stand assembly 100 rotates relative to the base assembly 20. That is, such variable resistance allows a user to adjust how hard or easy it is to rotate the stand assembly 100 relative to the base assembly 20.

With the alternative hinge pin assembly 60 of FIGS. 25-26B (and FIG. 27), as opposing nuts 65 are tightened against the counterbore surface 113CBS, the frictional force between inner face 114 (of hinge barrel 111) and outer face 56 (of hinge barrel 51) is increased. Such variable resistance allows a user to adjust how easily the stand assembly 100 rotates relative to the base assembly 20. That is, such variable resistance allows a user to adjust how hard or easy it is to rotate the stand assembly 100 relative to the base assembly 20.

Details of the hinge pin assembly 60 (of FIGS. 25-26B) are further shown in FIG. 27. FIG. 27 is a top view of a hinge pin assembly, in accordance with principles of the disclosed subject matter. As shown in FIG. 27, the hinge pin assembly 60 can include a threaded pin, threaded stud or threaded bolt 61, along with nut 65 and washers 66, 67. The washer 66 can include a spring lock washer (4 MM e.g.), a steel Belleville disc spring washer, or other washer. The washer 67 can include a lock washer, external tooth lock washer, or other washer. The nut 65 can be a nylon lock washer, so as to resist unwanted loosening or tightening. Other pins, nuts, screws, washers and/or other mechanical arrangement can be utilized as desired so as to connect the stand 20 with the platform assembly 100.

It is appreciated that mechanical attachment arrangements as described herein may be switched or flipped as may be desired. That is, for example, a protuberance on a first element that engages with a recess in a second element can be switched so that the protuberance is on the second element and the recess is on the first element. For example, a pin in a first element that engages with a slot in a second element can be switched so that the pin is in the second element and the slot is in the first element. Other mechanical arrangements as described herein can be switched as desired. For example, a male attachment element in a first element that engages with a female attachment element in a second element (for example, a ball and socket arrangement) can be switched so that the male attachment element is in the second element and the female attachment element is in the first element. Further, the hinge barrel arrangement may be switched from that shown in FIG. 1, i.e. a pair of hinge barrels may be provided on the base 20 and a single hinge barrel provided on the stand assembly 100.

The body of the “platform assembly”, which is rotatable and slidably supports the gripper assemblies, can be of construct that is symmetrical about both a horizontal centerline and about a vertical centerline, of such body, in at least one embodiment, i.e. in at least one version, of the support device. Such construct can be beneficial from a manufacturing perspective.

In general, in addition to the attachments described above, it is appreciated that suction cups in general can be used upon the various components as described herein as may be desired, so as to attach an element to a supporting surface. For example, one or more suction cups can be attached to the base assembly 20 and/or other components so as to attach such components to a supporting surface.

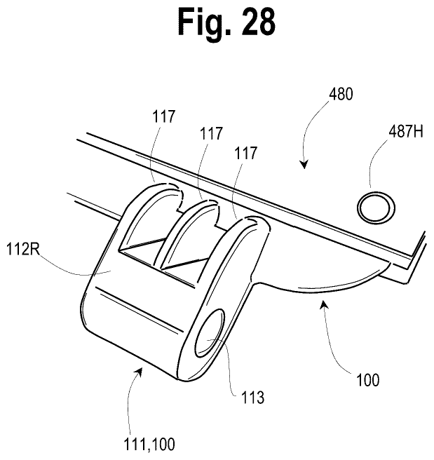

FIG. 28 is a back, partial view of a lower back corner of a stand assembly 100, in accordance with a further embodiment of the disclosure. FIG. 28 shows hinge barrel 111 with back face 112R.

The hinge barrel 111 includes hinge pin hole 113. The hinge barrel 111 connects to the back of the stand body portion 101 of the stand assembly 100. In particular, the hinge barrel 11 can connect to edge support portion 240 (of the stand assembly 100), which is shown in related FIG. 6. FIG. 28 also shows sliding drawer 480 with hole 487H for a ball plunger (see related FIG. 22). The hinge barrel 111 serves to rotatably support the stand assembly 100, as described herein.

As shown in FIG. 28, the hinge barrel 111 can be constructed with ribs 117. Such construct can be used instead of the solid barrel construct shown in FIG. 6. The ribs 117, as shown in FIG. 28, can be used to provide additional structural strength, reduce weight, reduce material used, and provide aesthetic appeal. As shown in FIG. 28, three ribs can be provided, each rib with opposing sides. Any number of ribs may be used as desired, such as for example, two ribs, three ribs (as shown), or four ribs. The ribs 117 can be connected and/or integrally formed with the lower corner of the stand body portion 101 of the stand assembly and/or the edge support portion 240 of the stand assembly. A similar hinge barrel can be provided on the opposing side,, i.e. an opposing corner of the stand assembly, as compared to that shown in FIG. 28.

It is appreciated that various embodiments are described herein. It is appreciated that a particular feature of a particular embodiment described herein might be utilized in other embodiments described herein, as desired.

As described above, the device of the disclosure in accordance with the various embodiments may be made from any of a wide variety of materials, as desired. For example, one embodiment of the support device can be made of plastic and/or metal. However, the device of the disclosure, in whole or in part, might be made of any other material, as desired, as described further below. The support device 10 may be used to support any of a wide variety of personal electronic devices, or other items, and is not limited to those described herein. Accordingly, the support device 10 may be used to support an electronic tablet computer, a cell phone, other telephone, personal digital assistant (PDA), calculator, monitor, remote control unit, or other personal electronic device, or any other item, such as a writing pad, recipe card, document, or book, for example.

The various components of embodiments of the disclosure may be made from any of a variety of materials including, for example, plastic, plastic resin, nylon, metal, aluminum, composite material, foam, rubber, wood, and/or ceramic, for example, or any other material as may be desired. For example, the device(s) of this disclosure may be produced from a plastic resin, such as polyethylene, and be injection molded.

A variety of production techniques may be used to make the apparatuses as described herein. For example, suitable injection molding and other molding techniques and other manufacturing techniques might be utilized. Also, the various components of the apparatuses may be integrally formed, as may be desired, in particular when using molding construction techniques. Also, the various components of the apparatuses may be formed in pieces and connected together in some manner, such as with suitable adhesive and/or heat bonding.

The various apparatuses and components of the apparatuses, as described herein, may be provided in various sizes and/or dimensions, as desired.

It will be appreciated that features, elements and/or characteristics described with respect to one embodiment of the disclosure may be variously used and combined with other embodiments of the disclosure as may be desired.

In this disclosure, quotation marks, such as with “connection portion”, have been used to enhance readability and/or to parse out a term or phrase for clarity.

It will be appreciated that the effects of the present disclosure are not limited to the above-mentioned effects, and other effects, which are not mentioned herein, will be apparent to those in the art from the disclosure and accompanying claims.

Although the preferred embodiments of the present disclosure have been disclosed for illustrative purposes, those skilled in the art will appreciate that various modifications, additions and substitutions are possible, without departing from the scope and spirit of the disclosure and accompanying claims.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present.

It will be understood that when an element or layer is referred to as being “onto” another element or layer, the element or layer can be directly on another element or layer or intervening elements or layers. Examples include “attached onto”, secured onto”, and “provided onto”. In contrast, when an element is referred to as being “directly onto” another element or layer, there are no intervening elements or layers present. As used herein, “onto” and “on to” have been used interchangeably.

It will be understood that when an element or layer is referred to as being “attached to” another element or layer, the element or layer can be directly attached to the another element or layer or intervening elements or layers. In contrast, when an element is referred to as being “attached directly to” another element or layer, there are no intervening elements or layers present. It will be understood that such relationship also is to be understood with regard to: “secured to” versus “secured directly to”; “provided to”versus “provided directly to”; and similar language.

As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present disclosure.

Spatially relative terms, such as “lower”, “lowest”, “top”, “upper”, “bottom”, “left”, “right” and the like, may be used herein for ease of description to describe the relationship of one element or feature to another element(s) or feature(s) as illustrated in the drawing figures. It will be understood that spatially relative terms are intended to encompass different orientations of structures in use or operation, in addition to the orientation depicted in the drawing figures. For example, if a device in the drawing Figs. is turned over, elements described as “lower” relative to other elements or features would then be oriented “lower” relative the other elements or features. Thus, the exemplary term “lower” can encompass both an orientation of above and below. The device may be otherwise oriented (rotated 90 degrees or at other orientations) and the spatially relative descriptors used herein should be interpreted accordingly.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to diagrams and/or cross-section illustrations, for example, that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of components illustrated herein but are to include deviations in shapes that result, for example, from manufacturing.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, as otherwise noted herein, when a particular feature, structure, or characteristic is described in connection with any embodiment, it is submitted that it is within the purview of one skilled in the art to effect and/or use such feature, structure, or characteristic in connection with other ones of the embodiments.

Embodiments are also intended to include or otherwise cover methods of using and methods of manufacturing any or all of the elements disclosed above.

While the subject matter has been described in detail with reference to exemplary embodiments thereof, it will be apparent to one skilled in the art that various changes can be made, and equivalents employed, without departing from the scope of the disclosure.

All related art references discussed in the above Background section are hereby incorporated by reference in their entirety. All documents referenced herein are hereby incorporated by reference in their entirety.

In conclusion, it will be readily understood by those persons skilled in the art that the present disclosure is susceptible to broad utility and application. Many embodiments and adaptations of the present disclosure other than those herein described, as well as many variations, modifications and equivalent arrangements, will be apparent from or reasonably suggested by the present disclosure and foregoing description thereof, without departing from the substance or scope of the disclosure.

Accordingly, while the present disclosure has been described here in detail in relation to its exemplary embodiments, it is to be understood that this disclosure is only illustrative and exemplary of the present disclosure and is made to provide an enabling disclosure of the disclosure. Accordingly, the foregoing disclosure is not intended to be construed or to limit the present disclosure or otherwise to exclude any other such embodiments, adaptations, variations, modifications and equivalent arrangements.

What is claimed is:

1. A support device for holding an item, the support device comprising:
a base;
a stand assembly, including a stand body, pivotally attached to the base by a hinge, and the stand assembly including a first rotation assembly;
a platform assembly that includes a second rotation assembly, and the second rotation assembly engaged with the first rotation assembly such that the platform assembly, with second rotation assembly, is rotatably attached to and supported on the stand body of the stand assembly; and
the platform assembly is rotatably and removably supported on the stand body, and
the platform assembly including an attachment mechanism that is configured to attach to a user device, the attachment mechanism including:
a first gripper assembly including a first gripper; and
a second gripper assembly including a second gripper,
the first gripper assembly and the second gripper assembly being of the same construct so as to be interchangeable.

2. The support device of claim 1,
the first gripper assembly slidably received into a body of platform assembly; and
the second gripper assembly slidably received into the body of platform assembly, on an opposing side of the platform assembly as compared to the first gripper assembly, so as to retain the user device between the first gripper assembly and the second gripper assembly.

3. The support device of claim 1, the second rotation assembly is attached to the first rotation assembly by a screw,
the first rotation assembly including spring loaded ball plungers;
the second rotation assembly including holes, and the spring loaded ball plungers respectively engaging with the holes so as to constrain rotation of the platform assembly relative to the stand assembly.

4. The support device of claim 1, the platform assembly including:
a body portion providing a gearbox; and
the attachment mechanism including a left gripper assembly, constituting the first gripper assembly, and a right gripper assembly constituting the second gripper assembly,
the left gripper assembly adjustably extending from left of the gearbox,
the right gripper assembly adjustably extending from right of the gearbox, the left gripper assembly and the right gripper assembly being mechanically linked, by at least one gear in the gear box, to open or close with each other, and
the left gripper assembly and a right gripper assembly configured to support the user device.

5. The support device of claim 4,
the left gripper assembly includes a first left support rod and a second left support rod, which are both slidably supported in respective channels in the platform assembly; and the right gripper assembly includes a first right support rod and a second right support rod, which are both slidably supported in further respective channels in the platform assembly.

6. The support device of claim 5,
the first left support rod including a first gear rack that is engaged with a first timing gear of the gearbox;
the second left support rod including a second gear rack that is engaged with a second timing gear of the gearbox;
the first right support rod including a third gear rack that is engaged with the second timing gear of the gearbox;
the second right support rod including a fourth gear rack that is engaged with the first timing gear of the gearbox.

7. The support device of claim 6,
the first timing gear provided in a first cavity of the gearbox, the first gearbox provided with a first gearbox cover, and
the second timing gear provided in a second cavity of the gearbox, the second gearbox provided with a second gearbox cover.

8. The support device of claim 7, the first left support rod including a first channel that houses a first spring, the first spring positioned against a first tab on the first gearbox cover so as to bias the first left support rod closed;
the second left support rod including a second channel that houses a second spring, the second spring positioned against a first tab on the second gearbox cover so as to bias the second left support rod closed;
the first right support rod including a third channel that houses a third spring, the third spring positioned against a second tab on the first gearbox cover so as to bias the first right support rod closed;
the second right support rod including a fourth channel that houses a fourth spring, the fourth spring positioned against a second tab on the second gearbox cover so as to bias the fourth right support rod closed.

9. The support device of claim 1, the first rotation assembly including a recessed center platform, and
the second rotation assembly including a mating attachment boss that is configured to engage with the recessed center platform; and
the first rotation assembly including a screw, and the first rotation assembly attached to the second rotation assembly by the screw.

10. The support device of claim 1, further including a slide drawer that is extendable out from the stand assembly,
the slide drawer slidably received into the stand assembly, the slide drawer including a tray to hold an object.

11. The support device of claim 1, further including a slide drawer that is extendable out from the base assembly,
the slide drawer slidably received into the base assembly, the slide drawer including a tray to hold an object.

12. The support device of claim 1, further including:
a first slide drawer that is extendable out from the base assembly, the first slide drawer slidably received into the base assembly, the first slide drawer including a tray to hold an object; and
a second slide drawer that is extendable out from the stand assembly, the second slide drawer slidably received into the stand assembly, the second slide drawer including a further tray to hold a further object.

13. The support device of claim 1, the support device adapted to hold an electronic tablet or an electronic cell phone.

14. The support device of claim 1, the hinge including a first hinge barrel that is attached to the base and at least one further hinge barrel that is attached to the stand assembly.
